(19) United States
(12) Patent Application Publication
(10) Pub. No.: US 2015/0302252 A1
(43) Pub. Date: Oct. 22, 2015

(54) AUTHENTICATION METHOD USING MULTI-FACTOR EYE GAZE

(71) Applicant: Lucas A. Herrera, Atlanta, GA (US)

(72) Inventor: Lucas A. Herrera, Atlanta, GA (US)

(21) Appl. No.: 14/687,260

(22) Filed: Apr. 15, 2015

Related U.S. Application Data
(60) Provisional application No. 61/980,262, filed on Apr. 16, 2014.

(51) Int. Cl. G06K 9/00; G06K 9/46; G06T 7/00; H04L 29/06; G06K 9/62

(52) U.S. Cl. CPC G06K 9/00617; H04L 63/0861; G06K 9/0061; G06K 9/6201; G06T 7/004; G06K 9/46; G06K 9/00268; G06K 9/00624; G06K 2009/4666

(57) ABSTRACT

A method for rapid and robust one-step multi-factor authentication of a user is presented, employing multi-factor eye gaze. The mobile environment presents challenges that render the conventional password model obsolete. The primary goal is to offer an authentication method that competitively replaces the password, while offering improved security and usability. This method and apparatus combine the smooth operation of biometric authentication with the protection of knowledge based authentication to robustly authenticate a user and secure information on a mobile device in a manner that is easily used and requires no external hardware. This method demonstrates a solution comprised of a pupil segmentation algorithm, gaze estimation, and an innovative application that allows a user to authenticate oneself using gaze as the interaction medium and biometrics to authenticate an individual's facial structure.

This application claims the benefit of priority to U.S. Provisional Patent Application Ser. No. 61/980,262 filed Apr. 16, 2014 entitled “A Novel Authentication Method Using Multi-Factor Eye Gaze” and incorporates its entire contents by reference.

### TECHNICAL FIELD

The technical field of the invention relates to a multi-factor authentication method for mobile devices incorporating both a password and biometric authentication to quickly and reliably authenticate the user without requiring external hardware.

### BACKGROUND

Advances in mobile computing and hardware platforms have enabled mobile devices to become extensions of their users. The category of mobile devices includes smart phones, tablets, ultrabooks, pads, personal data assistants and other intelligent consumer products that may combine telecommunications and Internet access with flexibility and mobility. Mobile application and service developers capitalize on these dynamic platforms by providing convenient applications and an interface to the Internet. The trade-off for this high flexibility and mobility is a unique set of security challenges. Cryptographic systems have struggled in several aspects, including ease of use and power consumption, and the user component that these cryptographic systems rely on continues to be the password. Users can now access financial, personal, health, and otherwise confidential information using their mobile devices, but security professionals, at least since 1979, have recognized the need for improved authentication. See Morris et al, Password Security: A Case History. Commun. ACM, page 594597.1 (1979).

In network security, an authentication protocol is the process by which an entity proves their identity. Authentication protocols are usually part of a larger cryptographic system used to secure privileged information from unauthorized entities. The mark of great engineering is an invention or system that disappears from the consciousness of the user, the goal being to provide the most convenient design and solution. Unfortunately for computing technologies, this goal flies in the face of security, where designers of web services and mobile applications have opted for convenience, shying away from implementing bulletproof security protocols. As a result, these technologies have cryptographic systems that operate behind the scenes, hidden from the user with the exception of the authentication portion of the system. Intrinsically, the user authentication steps must be exposed to the requesting entity. Many times this takes the form of a challenge and answer format. Valid authentication challenges can be grouped into three categories: (1) What the user knows, (2) What the user has, and (3) What the user is. These three authentication factors are summarized in FIG. 2 (Prior Art).

### Knowledge-Based Authentication

Knowledge based schemes are associated with the knowledge of some secret, or password, that is verified to validate a user's identity. Knowledge factor authentication is the most common type of authentication, since all password-centric schemes are based on knowledge-factor authentication. The authenticating system stores the secret and compares any future authentication attempts against this stored secret.

Generally a password is chosen by the user and communicated to the authentication system. For these user-created passwords, the authentication system typically places requirements on the length or content of the password to ensure that it will be sufficiently complex to avoid a brute force attack. Unfortunately an attacker can consider these requirements when developing a brute force attack, and the added complexity of these requirements becomes negligible.

Passwords can also be established mutually, with each entity contributing a portion of the secret and then both portions being combined to form the final secret to be used. A password can be given by the authenticating system, in which case the user is responsible for remembering it. A secret must not only be created, but it must also be known by both parties, and to be known it must be remembered. Remembering the secret is the main issue with this system.

The fundamental problem facing password implementations lies in the human factor. As O'Gorman alludes to in Comparing Passwords, Tokens and Biometrics for User Authentication, Proceedings of the IEEE, pp. 2021-2040, 1-2, the strongest vault can be attacked by exploiting a human mistake, just as the strongest encryption algorithm can be attacked by exploiting a weak password. The fact that the user is responsible for the password means that any password-based cryptographic system is a single point of failure once the password is compromised. For this reason, strong password choices are those that are sufficiently long and complex enough to resist social engineering. Such passwords conflict with the limitations of human memory, and users resort to either writing down their passwords or making shorter, thus weaker, passwords.

Physically or digitally recording passwords typically takes the form of the user compiling a library of all passwords in a file or note. Most users justify this behavior by the assumption that the contents of a file on their computer or a note on their desk would never be viewed by a malicious, untrusted user. However this behavior reduces all of a user's passwords down to a single point of failure that is not even protected in most cases. On the other hand, the users who correctly refuse to record their passwords must choose passwords that are easily remembered, but these easily remembered passwords are usually taken from life contexts like addresses, phone numbers, names, or words, which lend themselves to dictionary attacks and social engineering. An educated attacker who knows these contexts has a high likelihood of guessing the password. Many systems have been compromised due to poor security implementations and tenacious attackers, further demonstrating the gravity of the situation.

The authentication system also adds limitations on password security which must be considered. For the authentication system to know the information, in a computing application, means that the information must be stored in memory. Storing secure information in memory is comparable to writing a password down, so it automatically becomes a point of failure for any authentication system. Basically, the authentication system must record the secret in order to have knowledge of the secret, and this means that the secret must be hidden in order to be kept secret. The password must be encrypted or hashed before it is stored. Once stored, the password must remain hashed or encrypted as a security measure.

### Possession-Based Authentication

Possession-based authentication places emphasis on simple possession of a physical object or token. A key and lock is an example of a possession-based authentication scheme, where the lock is the authentication system that asks the question, “Do you have the key?”, and the key is the answer. Whoever possesses the key can successfully open the lock. This model does not translate well to virtual environments as possession is almost impossible to validate in a computing environment. The best approximation is to communicate via a specific device or provide information like a password that lies within that device, which indirectly proves possession of that device. However, solely relying on possession poses many issues.

Objects are easily lost or stolen, and lost objects may be found by a malicious user. Objects can also be duplicated, which is more difficult to detect as the duplicated object will be valid for as long as the genuine object is valid. Provisions must be made and precautions must be taken to prevent the use of stolen or duplicated objects.

Once objects are lost, stolen, or duplicated, the credentials of that object must be revoked. Upon revocation, a new object must be chosen or established. Unfortunately for some computing applications, revocation may mean that the entire account is irreparably compromised and must be replaced. This would be analogous to having to replace all the locks because the key was lost or stolen.

### Inherence-Based Authentication

This authentication scheme emphasizes the exhibition of a user's specific characteristic or property. Generally, inherence factors are synonymous with biometric factors, since biometrics are intrinsic human properties. More accurately, biometric methods are a subset of the set of inherence factors that can be used. However, biometric factors are the most suitable factors considering the requirements of authentication as they provide the finest granularity and should be able to accurately discriminate between similar attributes of different users. These systems can be characterized as having sensing and differentiating criteria.

Vulnerabilities and obstacles uniquely associated with biometric authentication are false-positives and false-negatives of the matching algorithm, replay attacks, irrevocable credentials, and extra equipment. See Almuairfi et al, IPAS: Implicit Password Authentication System, 2011 IEEE Workshops of International Conference on Advanced Information Networking and Applications pp. 430-435.

An illustrative example of an inherence factor authentication system can be found on most touch-sensitive interfaces using capacitance as the differentiating criteria. The touchscrccn of a smartphone realizes this authentication method by requiring input from an object that inherently has the capacitance of a finger. If the ability of an object to register touches with the screen is considered a privilege, and human fingers are the only objects privileged to register touches, then every time an object touches the screen, the object must authenticate that it is a finger in order to prove that it is authorized to interact with the device. In authentication terms, in order for the screen to register a touch, the object touching the screen must authenticate that it has the capacitance of a finger.

This complex array of statements demonstrates how using inherence-based authentication exhibits the greatest potential to disappear into the use of a system. A user never has to think twice about whether to use a finger to touch the screen, and the authentication disappears into the use of the screen.

In this way, more complicated biometric-based authentication systems seek to confirm the inherent properties of an entity with minimal conscious effort. For instance, facial recognition validates that a person has the same face, or face metrics, as a previously authorized user without any memorization or ensuring they have a token with them. For more sensitive implementations, the tolerance of what it takes to be considered becomes more accurate and less permissive.

Returning to the smartphone screen example to demonstrate the tolerance vulnerability of biometric authentication, an object that is not a finger, but merely has the same capacitance as a finger, which touches the screen will still register a touch. Furthermore, this invalid object (not a finger) will always have the privilege of registering touches. Anything else that holds the same (or similar within some tolerance) inherence property, capacitance in this case, will be able to authenticate. This brings up the greatest weakness of using a biometric authentication factor.

Biometric authentication is irrevocable, implying that any person who can authenticate once, will forevermore be able to gain access. This presents obvious challenges to a real-time system where the differentiating criteria is not or cannot be made specific enough. The ideal differentiating criteria must be able to distinguish between the most subtle variations in the data. Further complicating matters, is the competing necessity to convert analog biometric data to digital values.

The exact representation of a biometric measurement cannot be fully digitized, thus introducing quantization of the data. Uludag, Pankanti, Prabhakar, and Jain offer the principal variations in the presentation of biometric information in Biometric Cryptosystems: Issues and Challenges, Proceedings of the IEEE pp. 948-960 (2004), which are as follows: (1) Inconsistent—Natural biometric signal is a non-deterministic composition of the physiological trait. Intrinsic variation exists in creating a deterministic representation. (2) Irreproducible—Environmental or permanent physiological change can render biometric signals irreproducible and useless. (3) Imperfect Acquisition—Given perfect presentation, the signal acquisition may still introduce variation due to hardware interactions with the data, e.g. camera automatically compensating for lighting, thus altering the signal.

Although this conversion from analog to digital is absolutely necessary, it not only strips valuable information from the data, it also maps multiple analog values to the same digital representation and diminishes variation. At the same time, there will always be noise when dealing with sensor data, so quantization will normalize out some of the variations caused by noise. The risk is that contained in the noise component, some transient data will be the only discriminating information to separate the biometrics of two users. After acquisition of the biometric signal, some data processing is needed to correct variations before determining whether the acquired signal matches the stored representation of the signal. The signals should be aligned by matching keypoints in the signal. This should result in a rotation or shifting translation that will allow the data two distinct presentations which requires complex pattern recognition and decision-making algorithms.

### Single-Factor Authentication Systems: Existing Technologies

A single-factor authentication system requires challenging one of the authentication factors in FIG. 2, most commonly a password. While the front end of most password authentication systems might look the same, sharing an entry box for the username and password in common, implementations of knowledge-based authentication differ greatly, with some systems having more secure password management and communication than others.

Since keeping the password secret is the mutual responsibility of the user and the application developer. Almuairfi et. al. proposed in a system seeking to minimize the user's responsibility by expanding on a knowledge-based authentication scheme using graphical representations of passwords. This system relies on contextual information from the password and is inherently vulnerable to dictionary attacks, since an attacker observing the systems responses to multiple attacks could discern the context and make well-educated attempts. Over-the-shoulder, dictionary, and other social engineering attacks exploit the dependence of knowledge-based authentication on human factors. In addition, considering the web-enhanced nature of mobile devices, more frequent authentications of users to their devices lays the groundwork of a convincing case for the development of stronger, user-friendly authentication. As Skracic, Pale, and Jeren discuss in Knowledge Based Authentication Requirements, 2013 36^{th} International Convention on Information Communication technology Electronics Microelectronics, pp. 1116-1120 (2013), dynamically changing passwords may offer increased security; however, simple knowledge-based authentication schemes continue to offer users and designers the best combination of usability, scalability, and security in spite of their inherent vulnerabilities.

Today, little is known about the specifications, but Apple Inc. and Google have developed secure hardware components that allow embedded sensors to access information that is completely secure from other hardware components. Security is improved through exclusive bus lines that only communicate between a secure cache element on the CPU and a sensor on the device. Google has implemented this technology associated with a Near Field Communication chip that has secure bus lines to the CPU to communicate secure information.

Apple has implemented this technology using a special imaging device to capture unique points on a user's finger. This technology has been marketed as TouchID and has been integrated into the iPhone 5S. FIG. 1 (Prior Art) displays a feedback screen shown to a user during a TouchID authentication attempt. The imaging chip has secure bus lines and dedicated cache elements to securely handle the information. Unfortunately for users of TouchID, fingerprints can be replicated using household materials or by lifting a fingerprint from the devices case or glass screen See Almuairfi. Despite the potential security risks, TouchID debuted as the most popular biometric authentication implementation. This widespread disregard of risk can be most likely attributed to the consumer loyalty and trust in the Apple Inc. brand.

### Multi-Factor Authentication: Existing Technologies and Need for Improvement

A multi-factor authentication (MFA) procedure requires challenging at least two of the authentication factors from FIG. 2 (Prior Art). This requirement is essential in providing improved security over a one or two password system. Combining two factors provides added security, but more often than not, this comes at a high cost to the usability or scalability of the authentication scheme. To security professionals, the shortcomings of user-dependent passwords more than demonstrate the need for a viable alternative, but the reluctance of businesses and users to embrace more secure alternatives proves that the benefits of upgraded security do not yet outweigh the costs of reduced usability, increased complexity, and complete overhaul of the existing authentication system. See Mao et al, Painless Migration from Passwords to Two Factor Authentication, 2011 IEEE International Workshop on Information Forensics and Security pp. 1-6 (2011).

For this reason, Mao, Florencio, and Herley, professionals from the technology industry, have collaborated to propose a method which mitigates the disruptive change concerning an upgrade to a multi-factor system by adding a possession-based layer on top of a password system in the form of an additional server that verifies the possession of a trusted device. The possession verification via a secure PIN communicated from the additional server to an authenticating device, usually a mobile phone, uses a messaging medium such as voicemail, text, or email. All of this communication is triggered by a successful authentication through the existing framework. FIG. 3 illustrates the messages that are sent between the devices involved in an authentication attempt using the method proposed by Mao et al.

By requiring no removal of the legacy authentication framework and placing emphasis on ease of integration, Mao et al's approach is the most widespread implementation of MFA. Businesses have embraced this system, since its perceived security and low implementation overhead offers the least cost for an improved system, and further places emphasis on the need of a system to consider implementation costs as a priority. This system compromises potential multi-factor authentication (MFA) security by relying on possession of a trusted device and prioritizing integration over usability by authenticating in two distinct steps, as opposed to one. Combine the typical shoulder surfing attacks that plague mobile devices with the fact that trusted mobile devices are not always in the possession of their trusted users, and the result is a set of feasible and crippling attacks that exploit this system and the essence of mobile devices. The method proposed by Mao et al uses a message sent to a mobile device to authenticate the user of another device, and thus it is not applicable to securing the mobile device itself.

Other common authentication procedures claiming to achieve multi-factor authentication (“MFA”) employ only one authentication factor with multiple challenges, such as asking for a password and the answer to a challenge question. Authenticating in this fashion only validates the knowledge component of a user's identity. A procedure such as this is more accurately termed strong authentication, and the security offered does not fully benefit from a true MFA scheme.

Some MFA designs, such as that proposed by Liou, Egan, Patel, and Bhashyam, use a combination of the knowledge (password) and possession (cell phone or token) authentication factors. See Liou et al, A Sophisticated RFID Application on Multi-Factor Authentication, 2011 Eighth International Conference on Information Technology: New Generations, pp. 180-185 (2011). These designs have a two-phase identification process where the knowledge component and possession components are challenged not only independently, but also separately. This leads to a more cumbersome authentication step than a single factor design, and deters users not wanting to sacrifice the convenience of their mobile device for the security of their information. Fundamentally, this added step in two-step strategies does not lend itself well to the desirable trait of authentication systems to disappear into the use of a service.

The focus of Tiwari, Sud. Sanyal, Abraham, Knapskog, and Sug. Sanyal is to use a Transaction Identification Code and the Short Message Service (“SMS”) of mobile devices to realize a multi-factor scheme. See Tiwari et al, A multi-factor security protocol for wireless payment—secure web authentication using mobile devices, Technical Report, India Institute of Information Technology, p. 9. (2011). This system is designed to support mobile transactions and highly secure communication between banking servers, mobile devices, and Point-of-Sale (POS) machines. This system is not designed to secure access to the mobile device itself.

Similarly, the method implemented by Vipin, Sarad, and Sankar relies on a knowledge secret and a secret generated by a possessed token to authenticate users in a mobile commerce environment. See Vipin et al, A multi way tree for token based authentication, 2008 International Conference on Computer Science and Software Engineering, pp. 1011-1014 (2008). Similar to the systems discussed earlier, the two systems described by Tiwari and Vipin require multiple steps to fully authenticate, and do not offer users the necessary convenience to replace passwords. More importantly, possession factors in general have been shown to be difficult for users to manage and are not well suited for mobile device authentication.

Phiri, Zhao, and Agbinya introduce a novel approach to compose one authentication factor through the fusion of biometrics (fingerprint), device metrics, and pseudo metrics. See Phiri et al, Biometrics, device metrics and pseudo metrics in a multifactor authentication with artificial intelligence, 2011 6^{th} International Conference on Broadband and Biomedical Communications, pp. 157-162 (2011). The authors employ a combinatorial neural network that is trained to implement the authentication by reaching the activation potential when a certainty level has been achieved. Unfortunately, biometric data introduce a level of uncertainty that must be managed, but compounding that uncertainty in a fusion approach may greatly increase the probability of a false-positive. Generally, given the adaptive thresholding steps, neural networks are ill-suited for robust authentication systems.

Sun, Li, Jiang, and Kot implement MFA by sending two or three images of a user's face to an image database, computing a 40 digit hash from the user's face, and combining that with an image-based password. See Sun et al, An interactive and secure user authentication scheme for mobile devices, IEEE International Symposium on Circuits and Systems, ISCAS 2008, pp. 2973-2976 (2008). This approach indeed prevents over-the-shoulder attacks and allows for greater security; however, using a server for authenticating a user to a mobile device presents an obstacle for users attempting to access devices not connected to a wireless network, excluding this method from competition with the traditional password on mobile devices.

The comprehensive scheme proposed by Huang, Xiang, Chonka, Zhou, and Deng authenticates users based on verified password knowledge, smart card possession, and abstract biometric characteristics. See Huang et al, A generic framework for three-factor authentication: Preserving security and privacy in distributed systems, IEEE Transactions on Parallel ad Distributed Systems, pp. 1390-1397 (2011). Many concerns are addressed in this true three-factor approach, yet it omits the description of how biometric data are acquired. Fan and Lin also propose a three factor system, combining a password with a smart card and fingerprint. See Fan et al, Provably secure remote truly three-factor authentication scheme with privacy protection on biometrics, IEEE Transactions on Information Forensics and Security, pp. 933-945 (2009). Just as Huang, et al. lack an adequate mobile variety or feasibility for mobile platforms, the system proposed by Fan et al. suffers from the use of an authentication server requiring an internet connection. Thus, neither of these systems is ideal for securing mobile devices.

Ocular multi-factor approaches have been proposed by Millan, Perez-Cabre, and Javidi via a system using retinal images in response to specific images stored on an ID token or card to authenticate users by imaging the user's retina in situ. See Millan et al, Multifactor authentication reinforces optical security, Optics Letters, pp. 721-723 (2006). While this approach does offer a high degree of security, it requires expensive external imaging equipment and computational workloads difficult to integrate into current mobile platforms. None of the current authentication technology sufficiently combines authentication factors in such a way that enables the usability of passwords and the security of MFA in a system that is practical for mobile devices.

Defigueiredo sums up the need for a mobile two factor authentication solution by explaining that mobile device authentication provides a unique set of design constraints which expose problems never addressed by desktop authentication systems, such as device loss and phishing. See Defigueiredo, The Case for Mobile Two-Factor Authentication, IEEE Security Privacy, pp. 81-85 (2011). For a desktop system, loss is unlikely and phishing risk can be reduced by securing access at a software level, through an operating system or third-party application. Some laptops have integrated fingerprint scanners and smartcard readers, but widespread use has not been achieved, as these components offer little additional functionality and increase manufacturing costs. Since the vast majority of mobile applications require web access and some form of authentication, mobile device users are bombarded with authentication requests from the device or the web service, preventing the current security solutions from being ideal for mobile device applications.

In order to protect the information that is being stored on mobile devices and web servers, improved authentication steps are needed. Many works have focused on developing stronger authentication processes, but security professionals do not typically focus on usability, and application developers do not focus on security. Bridging this gap has proved difficult. See Bonneau et al, The Quest to Replace Passwords: A Framework for Comparative Evaluation of Web Authentication Schemes, 2012 IEEE Symposium on Security and Privacy, pp. 553-567.2, Herley et al, A Research Agenda Acknowledging the Persistence of Passwords, IEEE Security Privacy, pp. 28-36.2. See also O'Gorman, supra. The authentication scheme that will replace the pervasive password must offer improved security with the ease and convenience that passwords offer. Researchers and industry professionals cannot agree on how to improve the authentication process for mobile device users. Many researchers believe that multi-factor authentication is the answer, given the attacks and vulnerabilities associated with password approaches.

However, multi-factor schemes usually require added equipment and are expensive to implement. See Mao et al. The two-step approaches that the industry has adopted do not adequately improve security and are rarely used as they are optional for most applications and services. Id.

### Gaze Estimation Via Face Detection and Eye Tracking

Using the embedded user-facing camera available on the majority of mobile devices, biometric information can be collected and used for authentication. Biometric information extracted from an image exhibits unique characteristics that can be abstracted as features within an image.

Haar features are two-dimensional image features extracted by evaluating the integral of the image, or the sum of the image intensities, within rectangular sections of varying scales within the image. The rectangular image sections are selected by rectangular filters that seek out areas of dark intensity near areas of light intensity oriented in the same fashion as the filters. Viola and Jones designed a set of optimizations, known as Viola-Jones feature detection, that allow multiple filter stages to be developed and cascaded using AdaBoost training and tuning to provide real-time facial feature detection. See Viola and Jones, Rapid object detection using a boosted cascade of simple features, Proceedings of the 2011 IEEE Computer Society Conference on Computer Vision and Pattern Recognition, 2001. CVPR 2001, vol. 1, pp. 1-511-1-518 vol. 1.11.

Viola-Jones feature detection utilizes a set of classifiers that are ordered to allow for rapid and robust object detection. The ordering is done by offline training using AdaBoost, a machine learning algorithm. AdaBoost weights several imprecise classifiers that combine to provide a rapid and robust classifier, termed a cascade by Viola and Jones. The classifiers are organized by weight according to the false acceptance rate measured by AdaBoost measured on a training set, with the first filters allowing the greatest false positive rate and the last filters allowing a minimal false positive rate. The goal of this ordering is to optimize the performance of feature detection for speed and robustness. The first stage selects all candidates, while the succeeding stages progressively cull through the candidate set, rejecting ill-fitting members at each stage. This method will be used to detect the face and eyes of users during the process of authentication.

Recently, gaze tracking has garnered considerable attention in the fields of human-computer interaction (HCI) and biometrics. Eye-gaze has been identified for several applications, such as gaming interactions in Corcoran et al, fatigued driver recognition in Mei et al, and paraplegic assistance in Udayashankar et al. See Corcoran et al, Real-time eye gaze tracking for gaming design and consumer electronic systems, IEEE Transactions on Consumer Electronics pp. 347-355 (2012), Mei et al, Study of the eye-tracking methods based on video, 2011 Third International Conference on Computational Intelligence, Communication Systems and Networks, pp. 105 (2011), Udayashankar et al, Assistance for the paralyzed using eye blink detection, 2012 Fourth International Conference on Digital Home, pp. 104-108 (2012). Achieving reliable gaze estimation relies on the combination of face detection, eye region detection, and pupil or iris tracking. Haar cascades created by the Viola-Jones method can be used for both the face and the eye region detection.

Work done by Ephraim, Himmelman, and Siddiqi attests to the fast performance of the Viola-Jones detection algorithm. See Ephraim et al, Real-time Viola-Jones face detection in a web browser, Canadian Conference on Computer and Robot Vision, 2009, CRV '09 pp. 321-328 (2009). The authors were able to embed the algorithm using a slow scripting language in a web browser. The performance of the facial detection algorithm suffered little degradation in the scripting environment, and detection rates hovered above 90%. The work done by Mei et al., Udayashankar et al., and Jiang, Lu, Tang, and Goto all incorporate Haar features to quickly detect faces in real-time video. See Mei et al, Udayashankar et al. See also Jiang et al, Rapid face detection using a multi-mode cascade and separate Haar features, 2010 International Symposium on Intelligent Signal Processing and Communication Systems (ISPACS), pp. 1-4 (2010). In all three approaches, the Viola-Jones face detection algorithm is used successfully, followed by tracking of the eyes using image processing techniques.

Yan, Gao, and Zhang use glint detection to track the pupil, and obtain accurate, though not precise, results (78% accuracy) using the Hough transform to locate the circle representing the pupil. See Yan et al, Research on feature points positioning in non-contact eye-gaze tracking system, 9^{th} International Conference on Electronic Measurement Instruments, ICEMI '09, pp. 1042-1045 (2009). Several other works, including the work of C. Yang, Sun, J. Liu, X. Yang, Wang, and W. Liu use glint detection under adequate lighting conditions to simplify tracking the pupil. See C. Yang et al, A gray difference-based pre-processing for gaze tracking, 2010 IEEE 10th International Conference on Signal Processing (ICSP), pp. 1293-1296 (2010). See also Zhu et al, Novel eye gaze tracking techniques under natural head movement, IEEE Transactions on Biomedical Engineering, pp. 2246-2260 (2007). The techniques used by Zhu et al use two cameras and an external infrared LED light source to produce the glint used to track eye movement. Without special lighting conditions, however, the glint is not reflected in a deterministic fashion and cannot be relied upon to track the pupil region of the eye, so a novel method must be used to accommodate natural lighting conditions.

The efforts of Hennessey and Lawrence, with contributions from Noureddin estimate the point-of-gaze (POG, the subject's focal point in 3-D space) via off-axis infrared light sources and image processing of the corneal reflections those light sources produce. See Hennessey and Lawrence, Improving the accuracy and reliability of remote system-calibration-free eye-gaze tracking, IEEE Transactions on Biomedical Engineering, pp. 1891-1900 (2009); Hennessey and Lawrence, Noncontact binocular eye-gaze tracking for point-of-gaze estimation in three dimensions, IEEE Transactions on Biomedical Engineering, pp. 790-799 (2009); Hennessey, Noureddin et al, Fixation precision in high-speed noncontact eye-gaze tracking, IEEE Transactions on Systems, Man, and Cybernetics, Part B: Cybernetics, pp. 289-298 (2008). The results of this system support the most accurate POG estimation of all those considered, but the system requires an abundance of light sources mounted at the correct angles. Just as with the pupil detection methods described earlier, the directed lighting required for this method renders it infeasible for consideration in this algorithm.

Accurate gaze estimation that is head-movement tolerant and mobile platform friendly has yet to be developed. For this reason, a major goal of the work reported herein is the development of accurate gaze estimation to accommodate mobile devices with neither external hardware nor special lighting conditions.

### Gaze-Based Authentication

Bednarik, Kinnunen, Mihalia, and Franti studied gaze-tracking as an authentication factor for desktop computers. See Bednarik et al, Eye-movements as a biometric, in Kalviainen et al. editors. Image Analysis No. 3540 in Lecture Notes in Computer Science, Springer Berlin Heidelberg, pp. 780-789 (2005). Using acceleration and gaze velocity of pupil movement, as well as its size, the authors observed 60 percent accuracy, but the eye-movements were tracked using infrared light and algorithms that were intolerant of blinking and head movement. Later, Liang, Tan, and Chi expanded on this by measuring acceleration, geometry, and muscle information of the ocular region, to provide 34 features to a classifier. See Liang et al. Video-based biometric identification using eye tracing technique, 2012 IEEE International Conference on Signal Processing, Communication and Computing, pp. 728-733 (2012). The classifier method discriminates users based on the commonality of the transient response of the eyes to a stimulus video. Maeder and Fookes use the stimulation from a specific visual scene to measure the unique response of a user's gaze, the points in the images where the user focuses, and iris width for identification purposes. See Maeder and Fookes, A visual attention approach to personal identification, Faculty of Built Environment and Engineering; School of Engineering Systems, pp. 1-7 (2003). These methods require high resolution, continuous images of the eyes to accurately measure fine eye movements, known as saccades, which cannot be maintained by mobile devices.

De Luca, Weiss, and Drewes proposed a novel method of PIN-entry for ATM systems using eye-gaze. See De Luca et al, Evaluation of eye-gaze interaction methods for security enhanced PIN-entry, Proceedings of the 19^{th} Australasian conference on Computer-Human Interaction: Entertaining User Interfaces, p. 199202, New York, N.Y., USA (2007). The motivation of the work is to mitigate the widely accepted risk of an attack known as shoulder surfing, whereby an active observer memorizes the PIN during a user's traditional and viewable keypad entry. Kumar, Garfinkel, Boneh, and Winograd and Kasprowski and Ober address this issue as well, with each effort showing, respectively through user studies, that gaze-based entry methods are preferred by a majority of users to protect against shoulder surfing attacks. See Kumar et al, Reducing shoulder-surfing by using gaze-based password entry, Proceedings of the 3^{rd} symposium on Usable privacy and security, p. 1319 (2007); Kasprowski and Ober, Eye movements in biometrics, in Maltoni and Jain, editors, Biometric Authentication, Lecture Notes in Computer Science, pp. 248-258, Springer Berlin Heidelberg.

The method of De Luca et al. presents a drawing pad to a user where, drawing with their eyes, they are able to enter their password. Although an eye-centric interface is a goal of the invention described herein, De Luca's method requires large and expensive equipment, as well as a stationary device, such as an ATM, and does not directly or indirectly represent a feasible solution for the mobile environment. Similarly, the gaze-based password entry system proposed by Kumar et al. requires a stationary camera, is designed for desktop use, and does not provide a feasible basis for mobile devices. Additionally, none of the previously observed gaze-based methods provide a multi-factor approach to mobile device authentication.

Iris scanning techniques for biometric identification are known in the art. Although an intriguing possibility as high resolution imaging continues to advance, iris scanning techniques do not currently lend themselves to a mobile platform without embedding specialized hardware. A state-of-the-art iris detection algorithm is disclosed in U.S. Pat. No. 7,444,007, issued Oct. 28, 2008. It is anticipated that hardware capable of performing iris scanning will become integrated into standard mobile devices in the future as mobile technology becomes more sophisticated. When it becomes technically feasible, it will become an option to use iris scanning to detect a user's pupils or eye gaze direction as part of the multi-factor authentication algorithm contemplated by this invention.

The prior methods developed for gaze-based authentication or multi-factor authentication do not present feasible authentication options for use in mobile devices. The factor limiting the use of any previously developed methods is gaze estimation under natural lighting conditions running on a mobile device.

Accordingly, there remains a need for a user-friendly multi-factor authentication method to secure mobile devices, and the present invention uses gaze estimation and face recognition to achieve this result. For mobile applications, where security is not the only consideration, users are very concerned with aesthetics and usability. Eliminating adoption obstacles for this technology further supports the goal of this system to adequately replace the popular, yet insufficient, password approaches currently employed on mobile devices. The design must support the primary goal of the system to authenticate users using a one-step multi-factor approach. Every aspect must accommodate the limitations of mobile deployed applications, while taking into account user expectations of convenience and effortless functionality.

### SUMMARY OF THE INVENTION

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

The present invention seeks to remedy the disadvantages of these approaches by combining the usability of passwords and the security offered by multi-factor authentication through a system using gaze pattern detection and estimation on mobile devices using their existing cameras. Using the eyes for human-device interaction, by employing gaze estimation, allows users to enter a password through subtle, inconspicuous eye movements that are difficult for third parties to detect and intercept. The present invention is an improvement of the security systems associated with accessing information on a mobile device or through a web interface accessed by a mobile device. The present invention combines the use of iris and other identifying biometric information with password security components to provide a highly usable authentication procedure that accomplishes multi-factor authentication in one step using existing hardware available on mobile devices. This authentication scheme specifically addresses user authentication to the mobile device, allowing the device to identify the user with greater certainty providing appropriate access.

The present invention is an apparatus and a method for authenticating a user of a mobile device comprising a display, a processor, and a camera built into the mobile device. The display displays an array of a plurality of different elements from which a sequence can be selected as an identification code. These elements can include numbers, letters, shapes, colors, objects, photographic images, drawings, patterns, or any combination of the above. The camera captures images of the user's face as the user gazes at the display and provides output to a processor, which initially locates the eyes within the image of the user's face, and then locates the pupils of the eyes. The processor then calculates the direction of the user's eye gaze on the display. One way that the processor can do this is by determining the locations of the center of the user's eye region and the center of the user's pupil, then calculating the difference between the center of the eye region and the center of the pupil. The processor then provides an output to the mobile device's memory indicating the direction of the user's gaze.

First, the device is taught to recognize the user's eyes and track the user's eye gazes in a calibration phase. The user performs a calibration test where the camera captures images of the user's gaze at specified points on the screen. The results are stored on the device's memory and are used to recognize the center point of the user's eye area in order to calculate the direction of the user's eye gaze. The results also allow the device to recognize eye gaze input only from specified users whose calibration test results are stored on the device, thus providing inherence-based authentication in addition to knowledge-based authentication.

Second, after the device is calibrated to recognize the user's eyes, the user selects a personal identification code during the password input phase. The user inputs the selected code into the device's memory via eye gaze which is captured by the camera. The personal identification code comprises a predetermined number of eye gazes in a sequence between four and ten eye gazes in length, with each eye gaze corresponding to an element shown in a location of the display.

Third, for subsequent authentication, the user inputs the selected identification code by gazing at the elements of the code shown on the display in sequence. The camera captures images of the user's face and eyes as the user inputs the identification code through a sequence of eye gazes, calculating and storing a direction of the user's gaze as the user looks at each element of the code in sequence. The processor converts those images into a code and outputs it to the device's memory where it is stored for user verification. The processor then authenticates the user by determining whether the stored sequence matches the previously selected identification code. The identification code input phase can also include random input feedback where the user gazes at moving color blocks on the display so that the processor can capture additional images of the user's eyes to identify the individual user by comparing with the images captured during the calibration test.

These and other aspects of the present invention are introduced in the following brief description of the drawings.

### BRIEF DESCRIPTION OF THE DRAWINGS

FIG. 1 depicts the training screen for Apple Inc.'s TouchID, a fingerprint-based authentication system known in the prior art which debuted on the iPhone 5s in October, 2013.

FIG. 2 is a table summarizing the three authentication factors (knowledge, possession, and inherence) known in the prior art and known applications thereof.

FIG. 3 depicts an outline for the user experience of a system using an authentication method known in the prior art and described by Mao et al (2007).

FIG. 4 is a flowchart illustrating the steps of how the present invention allows a mobile device to authenticate a user's identity using the disclosed multi-factor authentication method.

FIG. 5 depicts an example of the initial result of the gaze estimation algorithm, showing an image with the face and eye regions detected and marked by boxes, and the center of the pupil calculated and marked by a dot.

FIG. 6 is a screenshot of the Android application embodiment of the present invention showing the user's face and eyes detected and outlined by the application.

FIG. 7 depicts an example of an eye image captured and saved to the eye image database.

FIG. 8 depicts the k-means clustering algorithm for detecting three distinct areas of the eye image applied to three representative images from the eye image database. Applying the clustering algorithm results in distinct clusters equal to the constant, k, representing segments of the image and features of the specimen's ocular region. The iris/pupil area is assumed to be the segment of the image having the lowest average intensity.

FIG. 9 depicts an example of Daugman's Integrodifferential Operator used as an eye detection algorithm when it performs well.

FIG. 10 depicts an example of Daugman's Integrodifferential Operator used as an eye detection algorithm when it performs poorly.

FIG. 11A depicts an eye image from the eye image database identical to FIG. 7.

FIG. 11B depicts a threshold image of the eye image from FIG. 11A which results from processing the original image according to the first step of the morphological segmentation algorithm for eye detection, with pixels separated according to their value above or below a specified threshold.

FIG. 12A depicts the threshold image, shown in FIG. 11B, not yet processed to remove noise artifacts.

FIG. 12B depicts the result of the second step of the morphological segmentation algorithm for eye detection applied to the threshold image shown in FIG. 12A. The second step of the algorithm is a morphological erosion filter to remove noise artifacts from the threshold image.

FIG. 13A depicts the final result of the eye image processing steps shown in FIG. 11A, FIG. 11B, FIG. 12A, and FIG. 12B. FIG. 13A indicates the center of the iris area as detected by the algorithm with the lighter colored gray circle.

FIG. 13B depicts the center of the iris area as detected by the morphological segmentation algorithm indicated on the original eye image with a lighter colored gray circle.

FIG. 14 summarizes the performance of three iris segmentation algorithms (k-means clustering, Daugman's Integrodifferential Operator, and morphological segmentation) with several different eye color, skin color, and lighting variables.

FIG. 15 is a screenshot depicting one embodiment of the authentication application with a reference point of a neutral gaze in the center of the screen and a four by three matrix of colored blocks as the elements of the personal identification code.

FIG. 16A is an illustration of the vertical calibration phase with four blocks along a vertical axis for detecting and storing the user's eye position when gazing at those blocks.

FIG. 16B is an illustration of the horizontal calibration phase with three blocks along a horizontal axis for detecting and storing the user's eye position when gazing at those blocks.

FIG. 17 is a diagram showing an example of the computer system of a sophisticated mobile device, with camera, global positioning system and other components not shown.

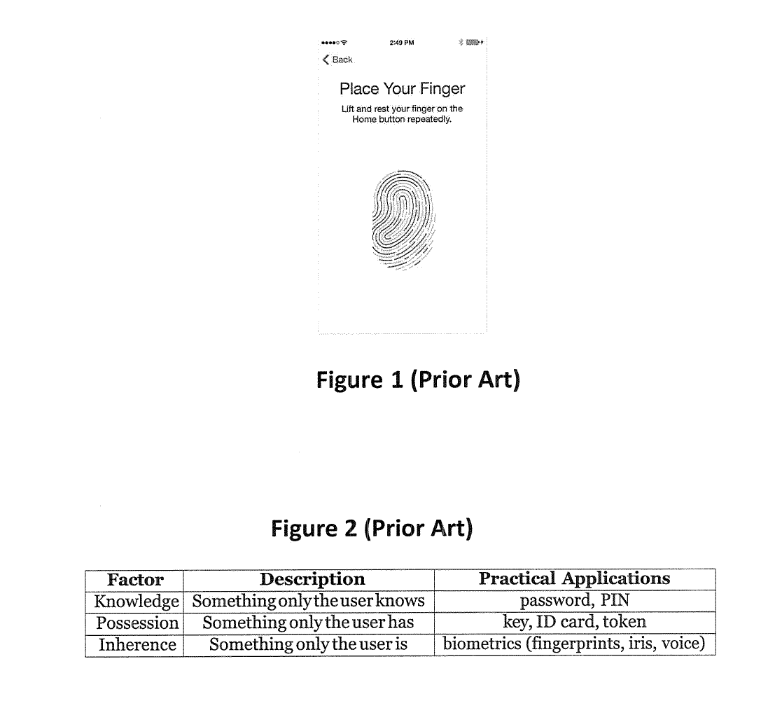

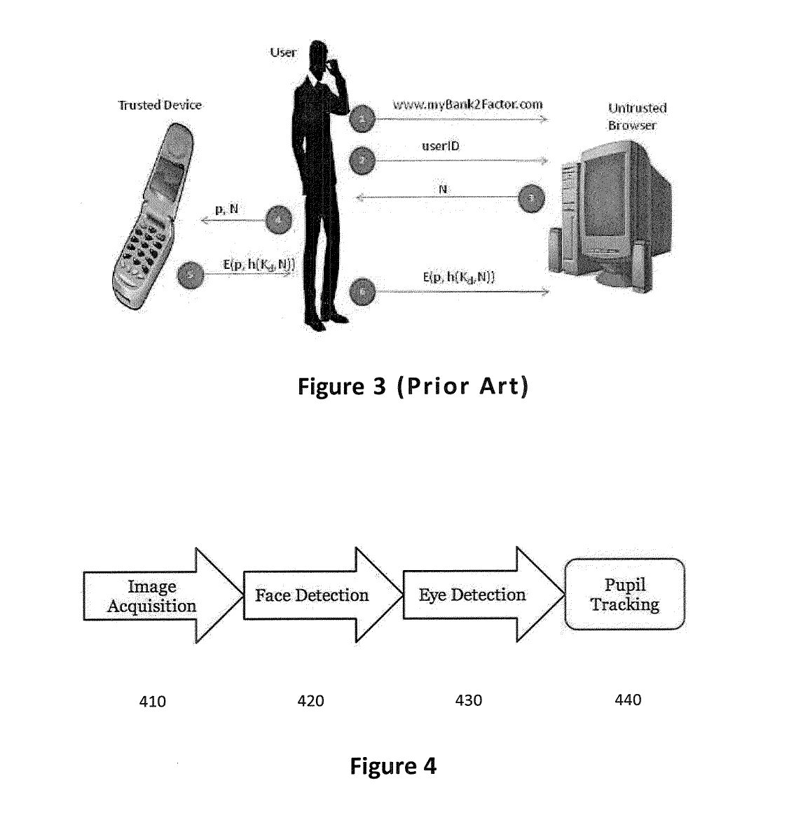

### DETAILED DESCRIPTION

The user authentication system of the present invention achieves multi-factor authentication on a mobile device by challenging two identifying factors, knowledge and inherence. A mobile device may comprise a smartphone, tablet, laptop, smart watch, personal digital assistant, ultrabook, or any other intelligent portable device with, for example, a display, a camera, a programmed processor, and a user interface. The primary obstacles facing the implementation of either function are mitigated through the complementary arrangement of the algorithm's flow. The knowledge factor allows the user to maintain the security of a password, and the biometric factor reduces the possible attacks that plague password systems.

Although the system operates and functions as a one-step system, several algorithms operate simultaneously to carry out the two factor procedure. The algorithm should be trained or calibrated to recognize and acknowledge only the user's eyes, and in this way, only the user's inputs will be received. This provides an extra level of security not present in current MFA approaches. This extra security, implemented in a fashion appealing to users, will be essential to fulfill the principal goal of this work—replace the password.

To promote adoption of this method, the experience of existing password interfaces will be preserved to the utmost, with the exception of the interaction medium. The user selects a personal identification code or number (PIN) composed of a sequence of any number (above a specified minimum) of digits, letters, shapes, colors, images, or other elements arranged on a screen, and an integrated camera provides images to a gaze estimation algorithm. Once the gaze point is established, an estimation algorithm projects the gaze point onto the device's screen, enabling the user to interact with the device and enter the PIN expressed as a sequence of blocks occupying specific positions. As an added layer of security, random input feedback is given to the user until authentication is complete. The random input feedback is provided through colored blocks that shuffle on the screen when an input is received. Using this approach, the user must rely on the phone to accurately estimate the gaze position, but the vulnerability of a malicious user observing the password is all but eliminated. This would require remote estimation of gaze point on the screens. Furthermore, this method capitalizes on the advantages of combining knowledge and biometric factors and mitigates many of the disadvantages of using either knowledge or inherence factors exclusively.

In providing a competitive replacement method of user authentication to a mobile device, a crucial design consideration is optimized implementation with respect to authentication accuracy, battery consumption, and duration for existing mobile platforms. All of the algorithms must be performed by a mobile optimized processor, limit unnecessary battery use, and operate using the integrated camera. Additionally, the flexibility of mobile devices allows a user to be in any environment. Ideally, the user would always be in the exact same environment with the same lighting conditions as those used for training the algorithm, however, this is not a reasonable assumption, so the detection and tracking algorithms must also address real-time issues such as non-static devices, inadequate lighting, and background image noise presented by ultrabooks, tablets, and smartphones.

Real-time video images from the device's integrated camera are to be processed for the extraction of images of the eyes, which are passed to the gaze estimation and recognition phases. FIG. 4 describes the flow of the algorithm. The first step of the algorithm is image acquisition 410 by the camera, followed by face detection 420, then eye detection 430, then pupil tracking 440.

Iris capture and scanning techniques are a known method for performing biometric authentication and processing images of a user's eyes, but are not yet practiced on mobile devices. It is not currently feasible to implement iris scanning techniques on typical mobile platforms because it requires specialized hardware not available on a standard mobile device. However, it is anticipated that hardware capable of performing iris scanning techniques will become a commonly available feature of mobile devices in the future. If iris scanning on mobile devices becomes feasible, it will be an obvious option to use iris scanning as part of this invention for iris and pupil detection and eye gaze tracking.

The initial hurdle to establishing ocular movements as a viable method for users to interface with their mobile devices centers on reliable detection of not only the ocular region, but the finer details of the region as well. Existing methods of gaze estimation rely on high resolution images and an infrared light source, but this invention aims to use the existing cameras integrated into mobile devices at the time of this writing, namely the user-facing cameras found in mobile devices. As these cameras are designed for transmitting video for video chat applications, the design emphasis of these cameras is the capture of low resolution images with a large field of view.

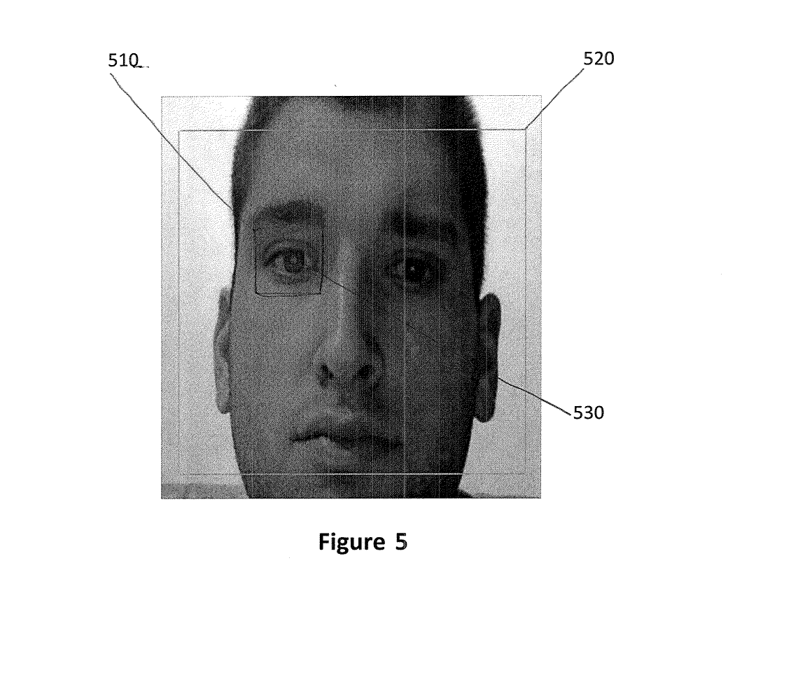

Haar cascades have been used in training and are used for detecting the user's face and eyes. In over 1000 runs during the development of this work, these cascades allow the face and eyes to be detected rapidly and reliably. The detection time using the cascades is directly proportional to the number of pixels in, or size of, the image, so reducing the image size that is passed to the feature detection algorithm greatly reduces the detection time. Optimizations are made so that the size of the image is reduced whenever possible before it is passed onto the subsequent processing stages. Vertical face alignment is assumed throughout the authentication process to standardize the feature detection. FIG. 5 illustrates an image of a user with the face and an eye image detected using the respective Haar cascade files, with the larger square 520 showing the user's face area as detected the algorithm, the smaller square 510 showing the user's eye area as detected by the algorithm, and a circle 530 showing the user's pupil as detected by the algorithm.

Referring to the algorithm depicted in FIG. 5, first, a scaled image (640×480 p) along with the face cascade is passed to the feature detection algorithm to detect the face. The feature detection algorithm returns rectangles containing any areas in the image identified by the cascaded face filter. The best match is selected according to appropriate size and matching confidence. The user's face is the first feature to be detected by the algorithm. If there are multiple faces in the image, the largest face in the image will be selected, with the assumption that the device will be decisively closer to the user who is trying to authenticate and would have the largest face in the images. The face detection portion of the algorithm returns the four points that form the corners of a rectangle which marks the face region. This face image can still be relatively large (400×300 p), so, in order to speed up the eye detection, a mask is placed on the face image. The mask is created by sub-sampling the face image by half vertically and horizontally. Then this half-sized image is passed to the eye detection step of the algorithm. Optimizing for the human anatomy, the eyes are found above the horizontal mid-line of the face, and one eye is located on either side of the vertical mid-line of the face. The same matching algorithm that yields the face image is again used to apply the eye cascade to the input image.

Similar to the face detection algorithm, a special eye Haar cascade is used to detect the specific eye region in the image depicted in FIG. 5. The top left corner of this region is particularly important, because it is used in the gaze estimation portion of the algorithm as well. While the algorithm detects an eye within the subdivided face region, the algorithm continues using the same face region. This step also greatly reduces time between image grabs, allowing the method to execute at standard video frame rates (20-30 frames per second). This region of the image is cropped and passed to the pupil tracking portion of the algorithm.

Before the pupil can be tracked, it must first be segmented from the image. In image processing, segmentation refers to the separation or identification of all pixels corresponding to a specific object, in this case, the pupil. This will be accomplished through rudimentary image processing operations, in the hopes of keeping the computation time as low as possible. Many extraction algorithms were explored during the initial stages of this work to establish the optimal segmentation method.

The Android operating system was chosen as a starting place to begin developing gaze-based multi-factor authentication mobile devices. The Android Software Development Kit (SDK) uses the Eclipse development environment with the Android Developer Tools plug-in installed. OpenCV, a library of programming functions written in C/C++ aimed at real-time computer vision, has been ported to the Android platform and implemented by the OpenCV4Android library. OpenCV4Android is released under a BSD license and gives Android applications access to the OpenCV API by linking to the C library at runtime.

### OpenCV4Android Application on a Smartphone

Initial work was targeted at demonstrating feasibility of accurate detection of a face, eyes, and eye details of a user with the mobile device within an arm's length. The OpenCV4Android library supports Haar cascade feature detection, and, as such, lends itself well to the purposes of this work. The application developed for the Android platform used the OpenCV Feature Detection Library to detect features in images based on a Haar cascade file. The images are acquired through the smartphone's forward facing camera. This integrated camera usually is designed with video chat applications in mind, and has a lower resolution imager better suited for real-time processing.

The application is straightforward and is designed to evaluate the feasibility of a smartphone's hardware to implement a real-time feature detection application. The application triggers the smartphone's camera to capture an image, and the image is passed to two feature detection steps. Using the method previously outlined, the first step calls a feature detection function that uses the face Haar cascade and returns an array of rectangles that contain facial components. The largest face rectangle is chosen, and the image is cropped to the rectangle of that face. This cropped and subsampled image is then passed to the eye detection function.

Along with the face subimage, an eye Haar cascade file is passed to the function. As before, the function returns an array of rectangular regions that correspond to rectangles that bound the components of the eye. After the best eye region has been returned, all of the rectangles are drawn on the screen, a new image is captured, and the detection process is repeated.

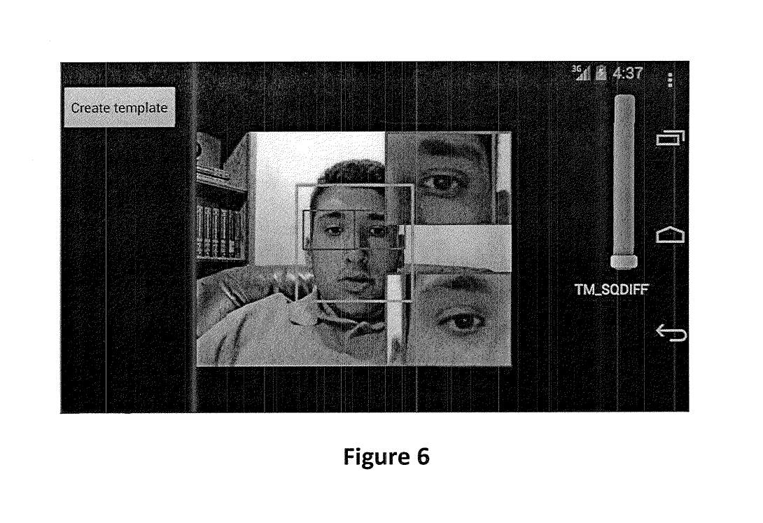

FIG. 6 shows the rectangles that are detected from the application and displayed on the smartphone's screen. FIG. 6 depicts a screenshot of the Android application with an image of the user marked with a larger rectangle corresponding to the user's face as detected by the application, two adjacent smaller rectangles corresponding to the user's eyes as detected by the application, and zoomed in images of each eye. With a static person, static device, and lighting conditions providing contrast for feature detection and gaze processing, the detection algorithm yields relatively accurate results.

### Eye Image Database

The goal in processing the eye region is to yield enough detail to authenticate the user and estimate the user's gaze direction and sequence. The first step in the evaluation is to compile a database of images that represent a diverse user population. An image acquisition script, written in SimpleCV, was created to automatically save the images that are generated by the eye detection algorithms.

SimpleCV employs the functionality of the OpenCV libraries using Python wrappers to give developers a way to rapidly prototype image processing applications. Along with current image processing support, the SimpleCV libraries also have webcam support, which allows real-time applications to be developed on computers without much initial setup overhead. Unfortunately these features come at the cost of execution time, which increases proportionately to the resolution of the images being captured. However, video frame rates can still be achieved with optimized and resourceful coding.

Using scripts to automate the image acquisition process, a diverse eye database was established to allow processing techniques to be developed that would extract the pupil location from the eye of the diverse images. Since the SimpleCV library and OpcnCV4Android library both link to the OpenCV library, this allows an ultrabook to capture images comparable to what can be achieved by the smartphone. The ultrabook used for this work is an Apple MacBook Air, with a dual-core 1.7 GHz Intel Core i7 processor and 8 GB of Random Access Memory.

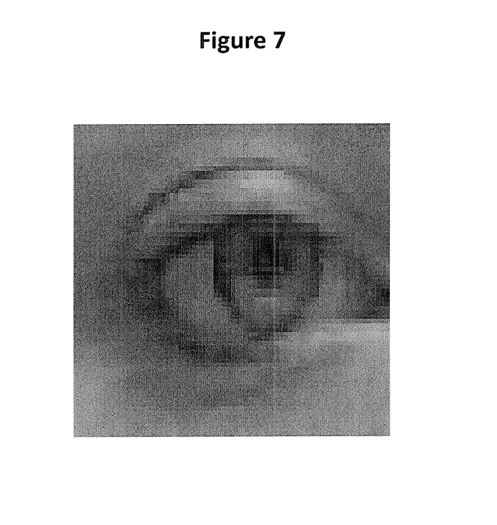

The same feature extraction algorithm is employed from the Android application, but this time, the cropped images of the detected face and eyes are saved as files, so that any language can interact with them. The eye image files were loaded into a database, since the organization of the images is important to determine the results of each segmentation method. FIG. 7 shows an example of the image quality and resolution of the eyes captured by an ultrabook's camera and contained in the database.

To ensure that the database represents a substantial number of eye presentations, over 325 eye images were collected from ten different subjects in five independent lighting conditions. The images are stored according to the subject and lighting fields in the database. No groundtruth information for the images is stored in the database. Although iris color is a relatively unique attribute, users were chosen based on distinctness of iris color. Lighting conditions were chosen based on type of lighting (incandescent, fluorescent, sunlight, etc.) and lighting angle (overhead, ambient, structured, etc.). Organizing this database by iris color and lighting, several eye processing techniques could be developed and rapidly tested on images of eyes to identify challenging combinations of iris color and lighting.

### Eye Image Processing Algorithms

The iris of the eye is segmented from the eye image in order to find the location of the pupil. Given the high contrast edge between the sclera and the iris of the eye, an edge based approach was initially deemed the most favorable. The iris and pupil areas are assumed to be concentric circles. MatlabQR was chosen as the development language, since the images from the database can be loaded by any MatlabQR script. For the initial implementation, images are processed at 960 by 1280 pixel resolution. This gives the processing algorithms sufficient information to detect facial features and track the pupils, while not inhibiting the experience for the user. The resolution is an important consideration, because a subject's eyes will likely represent a small portion of the pixels in each image, so the highest resolution that can be supported without reducing the frame rate is used.

In order to maximize the frame rate it is important to find the algorithm that presents the greatest potential to accurately and quickly calculate the center of the iris within the eye image. For this work, three methods were evaluated to determine their fitness for pupil segmentation using the sample images in the eye image database: k-Means Clustering, Daugman's Integrodifferential Operator, and Morphological Processing.

Eye Image Processing Algorithm 1: k-Means Clustering Algorithm

Clustering techniques are commonly used in image processing and computer vision applications to group pixels in an image based on similar features, usually color or intensity. In k-means clustering, k optimal clusters result, and the pixels of an image are classified to a cluster with respect to the minimum distance in color between each pixel and the average color of the closest, most similar cluster. This method was chosen because of the perceived distinctness in color of the different components of an eye image—skin, iris/pupil, sclera/whites.

The purpose of the k-means color-based segmentation method is the extraction of the colored iris region, containing both the iris and the pupil from the eye image. Before applying k-means, the colorspace of the image is transformed, allowing a stronger and more perceptual representation of the color content in the image. The eye image is first converted from the Red-Green-Blue (RGB) colorspace to the Lightness-Alpha-Beta (LAB) colorspace, where the alpha channel loosely corresponds to the red-green axis and the beta channel loosely corresponds to the blue-yellow axis. The alpha and beta channels are then clustered using k-means.

In this algorithm, the pixels of the eye image are grouped into k different components according to Euclidean distance between pixels, clustering the pixels that have the most similar color composition. This method operates under the assumption that three distinct color combination regions will be found (skin, iris/pupil, sclera/whites). Due to this, the eye images were clustered using k equal to three, and the pixels of the iris and pupil are found in the cluster with the lowest magnitude. Acceptable results can be expected in specimens where the skin is a noticeably lighter hue than the iris and pupil, but there are certainly cases where the iris and pupil may be lighter than the skin, due to either lighting or biology.

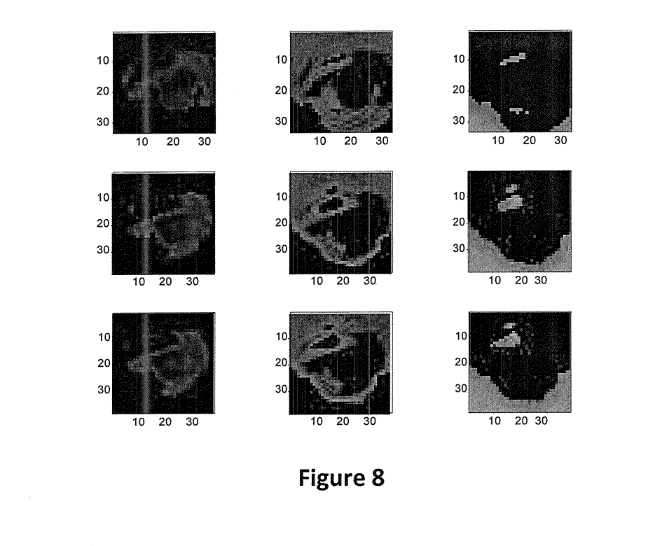

FIG. 8 shows results of the k-means clustering method with k=3 using representative images from the database. The images result from treating the k=3 segments of the original image as distinct images, and are sorted in ascending order of intensity. Specifically, the segment with the lowest average intensity (the “darkest” image) is in the first column of images. Visualizing the distinct segments validates the assumption that in well-suited specimens, the iris/pupil area of the image can be adequately segmented from the skin hue, since the darkest cluster of the image is assumed to be the iris/pupil.

After applying the k-means color-based segmentation method to several eye images with k=3, 4, 5, a more discriminating approach based on physiological assumptions was chosen.

### Eye Image Processing Algorithm 2: Daugman's Integrodifferential Operator

Observing the physiology of the human eye, the edge of the iris can be seen as a circular area of dark iris pixels bounded by an area of lighter pixels of the whites creates an edge. The goal of Daugman's Integrodifferential Operator is to fit a circle to the boundary of the darker circular area of the iris, yielding a center and radius of the circle. After the boundary information is obtained, the iris can be easily segmented as all pixels inside the circular boundary with the associated center and radius.

Daugman's Integrodifferential Operator is an exhaustive search algorithm that finds the boundary between the iris and whites of the eyes. The operator searches over circles of all radii at each given center for the maximum average intensity gradient from across each concentric circle boundary to the next, along the radius and the center of the circles. The operator is applied throughout the region of interest (ROI), and a Gaussian blur may be applied to smooth out any outlier noise that may cause erroneous results. The complexity of the algorithm is quite high since every pixel is observed R times, where R represents the number of radii to be processed, or once for every radius in the range between the minimum and the maximum radius. For every radius in the specified range, the normalized sum of the intensities of all circumferential pixel values is calculated for every pixel acting as a center. For every radius increase, the difference between the normalized sums of pixel intensity values of the adjacent circles is stored. After processing the entire range of radii, the center of the circle yielding the greatest edge is stated to be the center pixel of the iris, the boundary of which has the greatest change in circumferential pixels. Radman, Juwari, and Zainal present the algorithm implemented for this application in Radman et al., Fast and reliable iris segmentation algorithm, IET Image Processing, 7(1):42-49 (2013).

According to Radman's algorithm, the operator is governed by the following equation where 1(x, y) is the intensity at coordinates x, y: r is the radius of the circular region with the center at x0, y0; σ, held constant at 2, is the standard deviation of the Gaussian distribution; s is the contour of the circle given by (r, x0, y0) governed by the equation of the circle:

$${G}_{σ} * {max}_{r , x 0 , y 0} ( \frac{\partial }{\partial r} ∮ \frac{I ( x , y )}{2 π r} d s )$$

Since every pixel in the image is a potential center candidate, preprocessing steps can help mitigate long processing times. In fact, several assumptions are valid, which can greatly reduce the candidate locations for the pupil center. It is assumed that the center of the pupil will be dark (intensity value less than 50). This means that the only pixels passed to the algorithm will be those above a specified threshold intensity value. Unfortunately, lighting conditions can create a glint reflection off the eye, creating the potential where the center of the eye may not be passed to the algorithm as a result of the center pixel being left out of the algorithm. For this reason, any glints caused by incident or directed lighting of the cornea are filled.

Additionally, some mathematical operations, such as division, can be avoided if the neighbors of the dark pixels are observed to ensure that only the darkest pixels in the neighborhood are passed to the algorithm. Finally, it is assumed that the pupil is reasonably centered within the image, such that the best circle fitting the iris will never go outside the bounds of the image.

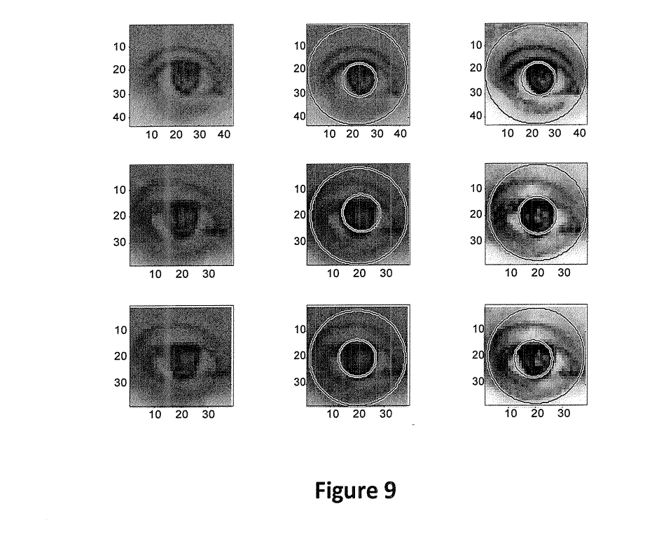

Referring to FIG. 9, the left column shows three original eye images captured by a mobile device's camera, the center column depicts the result of Daugman's operator applied to the original color images, and the third column depicts the result of the same algorithm applied to black and white versions of the original images. In the second and third columns, the outer circle indicates the algorithm's approximation of the corners of the eye, and the inner circle indicates the detected edge of the iris. As shown in the center column of FIG. 9, the added dimensionality of the color images adds more information to the edges and allows the algorithm to detect the true iris edge more accurately. However, this advantage illustrates the sensitivity of the algorithm's performance to color.

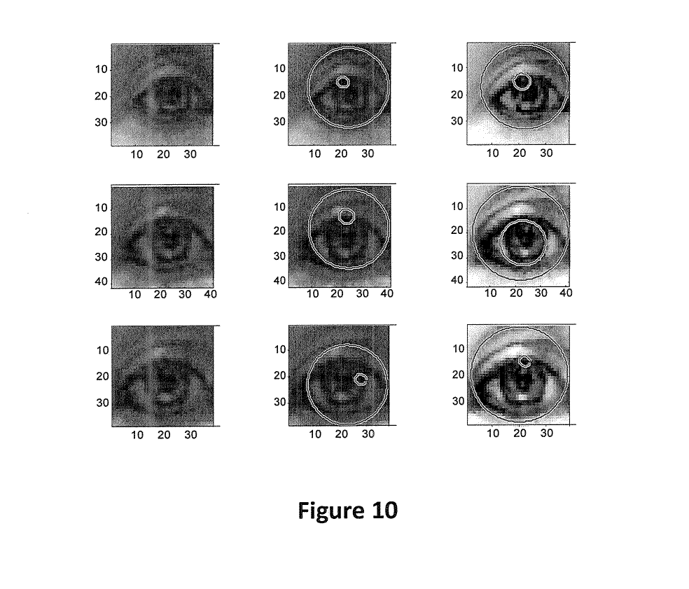

FIG. 10 shows the erratic behavior of the algorithm when the iris is not in high contrast to the whites of the eyes. The left column of FIG. 10 depicts original eye images captured by a mobile device's camera, the center column depicts the result of Daugman's operator applied to the original color images, and the third column depicts the result of the same algorithm applied to black and white versions of the original images. As in FIG. 9, the outer circles represent detected edges of the eyes and the inner circles represent detected irises. In spite of the strong analytical validity of Daugman's Integrodifferential Operator, this method does not achieve the appropriate results in some cases due to the averaging in the integration part of the algorithm. As is evident by the results shown in FIG. 10, the intensity values of noise in the skin can create an average differential that mimics the average differential of an eye edge. Additionally, the eye images do not present favorable data to the algorithm. The computational load that the operation requires is not well-suited for low performance processing in real-time environments. Due to the real-time operational requirements of the solution and the low-power processor, image resolution and ambient lighting present very real challenges to the implementation of pupil detection in natural light settings. An overlooked aspect of the eye image is the eyelashes, and occasionally the eyebrow, that are sometimes included in an eye image. Daugman's operator does not properly handle partially occluded irises due to the eyelashes. Eyelashes can cause a difficult situation where the irises are no longer detected, as the eyebrows may be in higher contrast to the whites than the iris.

Refocusing on algorithms that fulfill real-time constraints associated with image processing points to a solution employing rudimentary methods that have been coded and optimized in the SimpleCV library.

### Eye Image Processing Algorithm 3: Morphological Segmentation

Given the need for deterministic performance when extracting biometric information, a method with strong analytical integrity was initially sought out. After encountering obstacles with two deterministic approaches to the iris segmentation, developing a real-time segmentation approach became the main priority. Morphological segmentation uses nonlinear image filters, such as thresholding, dilation, and erosion. For this application, filters are selected that remove almost all information in the image except those pixels in the image representing the iris and pupil. Although this approach offers no theoretical guarantees regarding optimal segmentation, it successfully segments the iris area in real-time a high percentage of the time. This method is comprised of three simple processing techniques, implemented on every image that is taken, usually accurately yielding the center of the user's pupil when performed in sequence. The techniques described in this section are implemented using the same SimpleCV library that provides the feature detection. This allows the techniques to be seamlessly incorporated into one cohesive application that carries out the entire iris segmentation process, from image capture to identifying the center of the iris, whereas the previous methods would require intensive porting efforts.

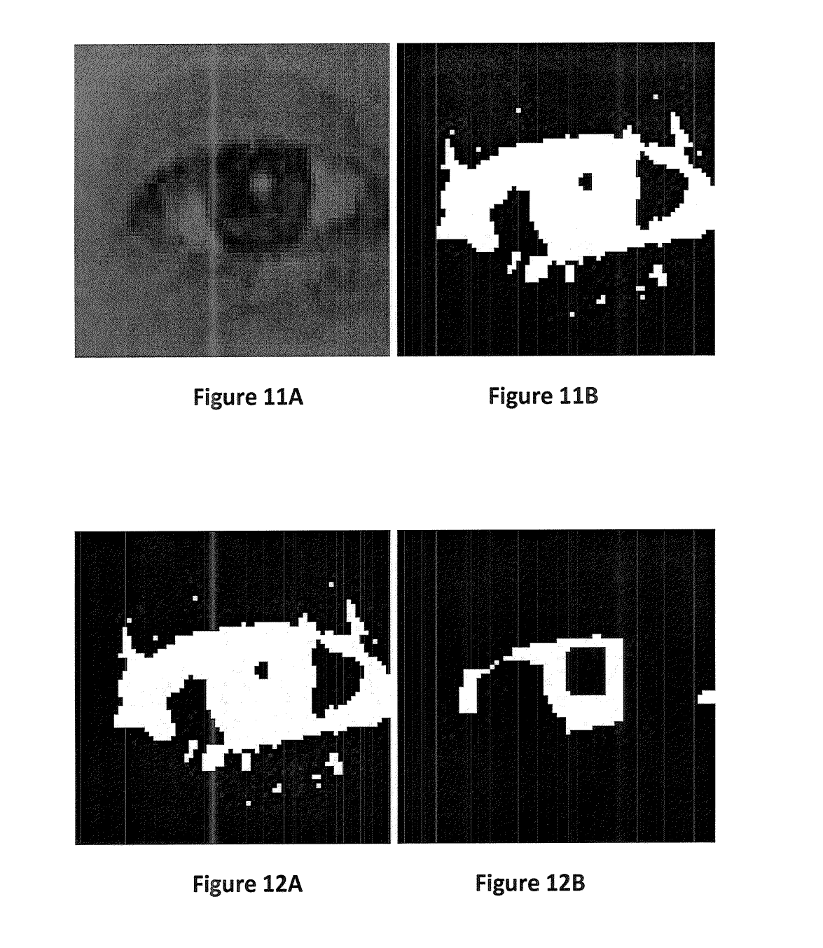

The first step in segmenting the iris area is reducing the eye image to a binary representation using an adaptive threshold. Since the pupil should be the darkest region in the image, this binary representation separates the image into two categories: (1) pixels of intensity above the threshold and (2) pixels with intensity below the threshold. The threshold must be calibrated by the user from observed lighting conditions in the given setting to provide accurate results. Future may be undertaken to develop a method for automated threshold selection. In the binary representation, the pixels that are below the threshold are classified with value 1, with all other pixels being ignored and classified with value 0. The output of the thresholding is shown in FIG. 11B, with the original image to which the thresholding was applied depicted in FIG. 11A.

After the thresholding, the binary image contains several binary regions comprised of the dark pixels from the image, including several noise artifacts that must be removed before the center of the iris can be calculated. To remove the remaining noise regions, a morphological erosion filter is applied to the image, removing sporadic noise elements of the skin and glares or glints in the eyes. The erosion operator removes pixels or regions of the binary image that do not have sufficient area to be the iris. The erosion operator is applied with a 3×3 mask, dictating that the minimum area of the iris region must be greater than nine pixels. All binary regions with less than seven neighbors are eliminated from the image. Since the edge pixels of the iris satisfy the elimination criteria for the erosion operator, those pixels must be restored after the erosion by applying a dilation filter to grow the areas. Dilation reconstitutes the regions of the image that still remain, and attempts to grow connected regions of the image. The results following both morphological processing steps are illustrated in FIG. 12B, with intermediate thresholding results to which the second step was applied depicted in FIG. 12A. After the noise has been filtered out and the legitimately dark regions of the image are restored using morphological processing, the largest remaining region in the binary image should correspond to the iris region in the original color image.

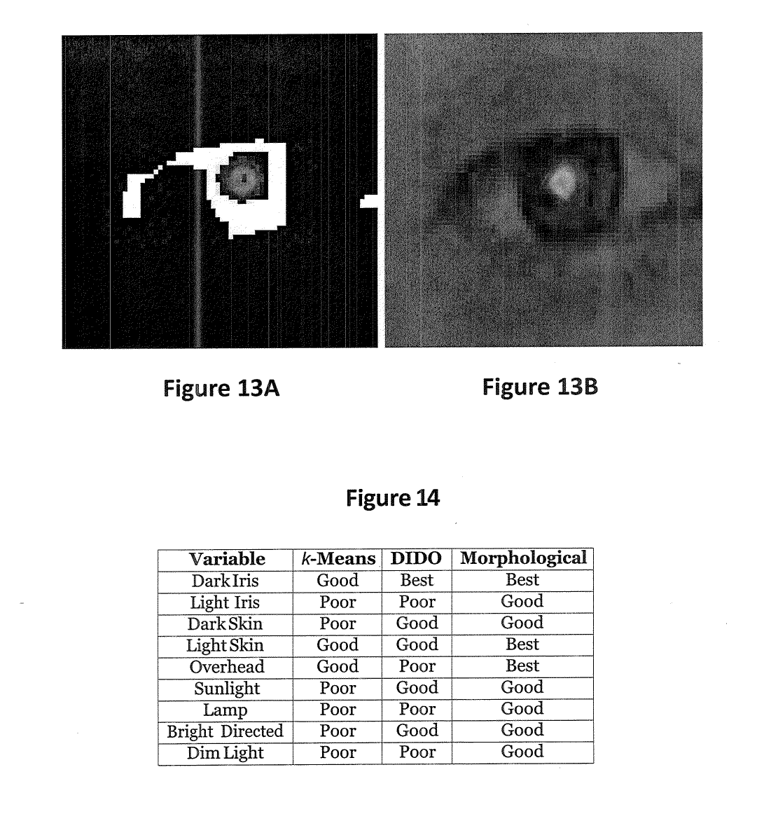

The final stage in segmenting the iris area from the eye image is calculating the center of the iris area to be used in estimating the user's gaze. The SimpleCV blob detection operator is used to calculate the center of the largest connected component in the image. The blob detection method returns a list of regions in descending order of area, so the first region, i.e. the region of largest area, is chosen. The method also provides the centroids of all of the regions. FIG. 13A depicts the result of the eye image processing with blob detection and centroid calculation, and indicates the detected center of the iris area with a lighter gray circular target in the center of the image. FIG. 13B depicts the original color image of the eye with the detected center of the iris marked with a lighter gray target, displaying notably accurate performance.

Using rudimentary image processing, real-time segmentation of the pupil can be achieved. While the method suffers from sensitivity to light and requires tuning, the performance of this simple algorithm is notably superior to the previous, more complex methods. The next development stage centered on the creation of the application visible to the user during authentication.

FIG. 14 summarizes the performance of the three implemented algorithms in the presence of varying conditions. The variables concern user features and lighting conditions of the eye subimages in the database. All performance measurements are judged manually by the eye ten to fifteen samples, and are indicated by the Poor, Good, and Best states. Poor performance indicates less than three successful segmentation attempts averaged over ten attempts. Good performance is achieved with more than five successful segmentation attempts, while Best performance status is noted when more than eight of ten attempts are successful on average.

Comparing the performance of the iris segmentation algorithms, the results show that the morphological processing approach performed most favorably. The thresholding step allows the method to adjust to varying lighting conditions. Even so, lamp and dim lighting are the harshest conditions for all of the methods. These lighting conditions do not provide the necessary illumination to allow confident segmentation of the eye images. Interestingly, overhead lighting casts a shadow on the user's eyes and causes a loss of contrast, reducing the accuracy of Daugman's algorithm. Light irises also pose a harsh challenge for the methods to deal with, due to the lack of contrast between the iris and the whites of the eyes. To mitigate this effect, the morphological processing approach is still able to segment the pupil area as this will usually be a dark area, with the exception of bright directed lighting. An intense glint may be reflected in the presence of bright directed lighting, causing the pupil region to have high intensity values instead of low intensity values. The perfect user environment would be a user with light skin and dark irises in an overhead lighting condition. This situation consistently provides the best results when applying morphological processing to the eye image database and during real-time operation.

### Application for User Device Authentication

This section describes an application that has been developed to carry out the present invention's authentication method using multi-factor eye gaze. The application performs its tasks in three phases. The first phase implements the calibration needed for the application to deliver accurate performance. The second phase requires the user to establish a personal identification code (hereinafter referred to as “PIN” for simplicity but not limited to a sequence of numbers, as the personal identification code can be composed of any sequence of elements that can be displayed on the device's screen) of user selected length for use in all subsequent authentication attempts. The third phase of the application allows users to securely enter their PINs using multi-factor eye gaze.

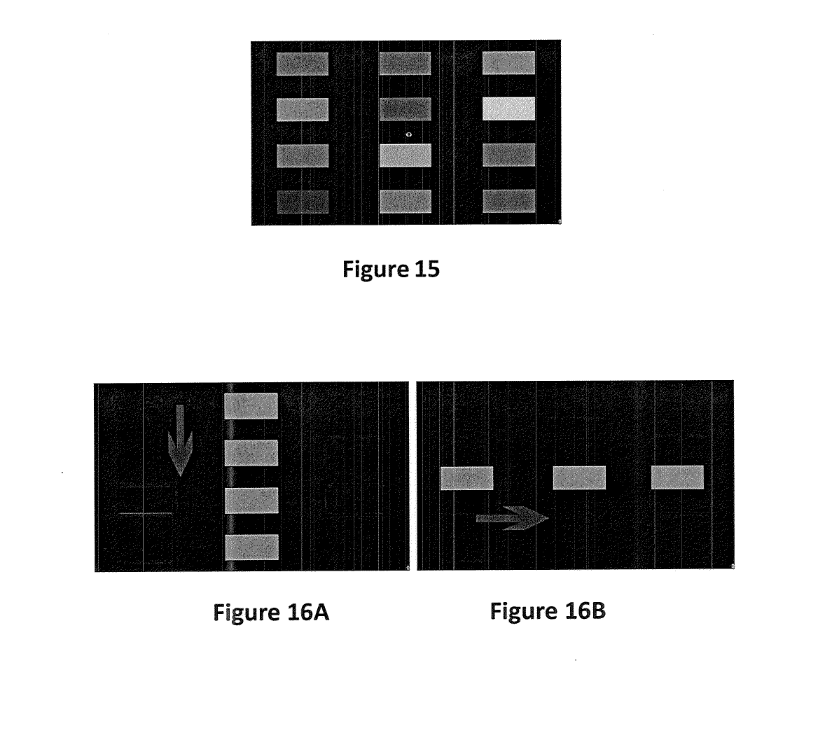

FIG. 15 shows an embodiment of the application's user interface, which was developed according to the design and requirements detailed above. To enter the PIN or password, the user must interact with the device using eye gaze. In the embodiment depicted in FIG. 15, twelve colored blocks are presented, by way of example, to the user, arranged in four rows and three columns, also by way of example. Other arrangements of the interface with different numbers of objects and different types of objects (which may include symbols, different shapes than blocks such as circles, colors, numbers, letters, words, images, patterns, etc.) can be used and are equivalent. Each block plays the role of a symbol, corresponding to its position, in a PIN. As the user's gaze settles on a chosen block for a sufficient amount of time (approximately 400 ms, for example, a range between 300 ms and 1 second), an input to the device is triggered. The colors of all of the blocks randomly change when an input is recognized, indicating to the user that an input has been received and the device is ready for the next input.

The application was developed using PyGame, the Python gaming library. It supports basic interface capabilities that were integrated into the existing pupil segmentation application. The pupil segmentation application outputs the center of the pupil, the user interface provides feedback to the user, and the gaze estimation framework translates the pupil center into a gaze point on the screen for the user interface.

Before implementation, the center of the eye region, depicted in FIG. 15 as an eye shaped image in the center of the screen, in the second column between the second and third rows, is first established to serve as the reference point of a neutral gaze. This point will be utilized during an authentication attempt to assess the direction of the user's gaze. If the subject maintains a neutral gaze by looking at the middle of the mobile device, the center of the pupil and the center of the eye region should be roughly the same. To estimate the point in space on the screen where the subject is gazing, the two-dimensional difference (Δx, Δy) between the reference center of the eye region and the pupil center is used. The output of the pupil segmentation step is the center of the extracted pupil segment. The center of the eye region can be calculated as the center of the eye subimage. It is important to remember that these points are not identical. For this reason, the center of the eye region is used as the reference point of a neutral gaze, to be taken and stored into the memory of the device.

For most subjects, the two centers will not align perfectly, so a translation constant must be calculated to offset the reference point or eye region center. If the subject looks away the eye region center and the pupil center are no longer at the same position, and the distance between these points is measured. The distance measurement is provided in its horizontal, Δx, and vertical, Δy components as a two-dimensional vector called the gaze vector, (Δx, Δy).

Through calibration steps, centroids for each block on the interface are then established to classify measured differences and represent estimated gaze point as screen coordinates. As opposed to requiring a calibration step for each block independently, resulting in twelve steps, vertical and horizontal centroids are calibrated by two independent calibration steps. The first step establishes the four vertical centroid points by prompting the user to gaze at each of the four central blocks along the vertical axis and averaging the vertical components of the gaze vectors across multiple samples, as shown in FIG. 16A. The second step calibrates the three centroids across the horizontal axis, as shown in FIG. 16B using the same method, resulting in seven calibration stages rather than twelve and reducing calibration time. After calibration is complete, every gaze vector that is sampled from a new image is classified according to the closest centroid in each direction. Classification of the gaze vector in this manner achieves the gaze estimation, and enables the application to perform the biometric portion of the authentication, but the knowledge factor remains to be established. After the calibration of the gaze estimation is complete, the application enters the next phase.

During the second phase of the application, the user establishes the length and value of the PIN to be used in all subsequent authentication attempts. This setup phase is required once. The user first chooses the length of PIN to create, with longer PIN selections providing more security and longer input times. The user selects among the range of lengths from four to seven symbols (more symbols should be used in a fielded system. After the length is chosen, the user creates the PIN that will be used for authentication. Creating the PIN is achieved through eye gaze to acclimate the user to the new interface.

Once the PIN is established, it is important that the PIN be stored into the device's secure and encrypted place in memory to protect it from any malicious memory attacks. This allows the PIN to be used securely during the third application phase until the user decides to manually recreate the PIN.

In the application's third phase of PIN entry, multi-factor authentication using eye gaze may be performed seamlessly. The user, when prompted with the authentication screen, gazes at the necessary positions of the blocks in sequence that represent the proper value to enter in the correct PIN established during the second phase. If the biometric features of the user's eyes do not correspond to the calibration established during the first phase, the application will not be able to authenticate successfully. Similarly, if the application recognizes the user's input, but the entered PIN is not the same as the one stored in the encrypted memory, authentication will fail. Only when both the biometric and the knowledge criteria are met will the user be able to successfully authenticate.

Through testing of the application, users other than the user who performed the calibration steps were rejected, and false positives were never encountered. Unfortunately, genuine users attempting to authenticate experienced false negative results. This indicates a high sensitivity of the biometric recognition portion of the application to something other than the user and the password and has been identified as future work.

Since the gaze estimation of the application is based on the morphological segmentation algorithm, the performance of the application is subject to the same limitations as the morphological segmentation algorithm, namely the lighting conditions. As a result, authentication attempts using the application must be performed under lighting environments similar to the calibration environment. Further embodiments of the present invention include automatic compensation for lighting conditions to increase the performance of the algorithm.

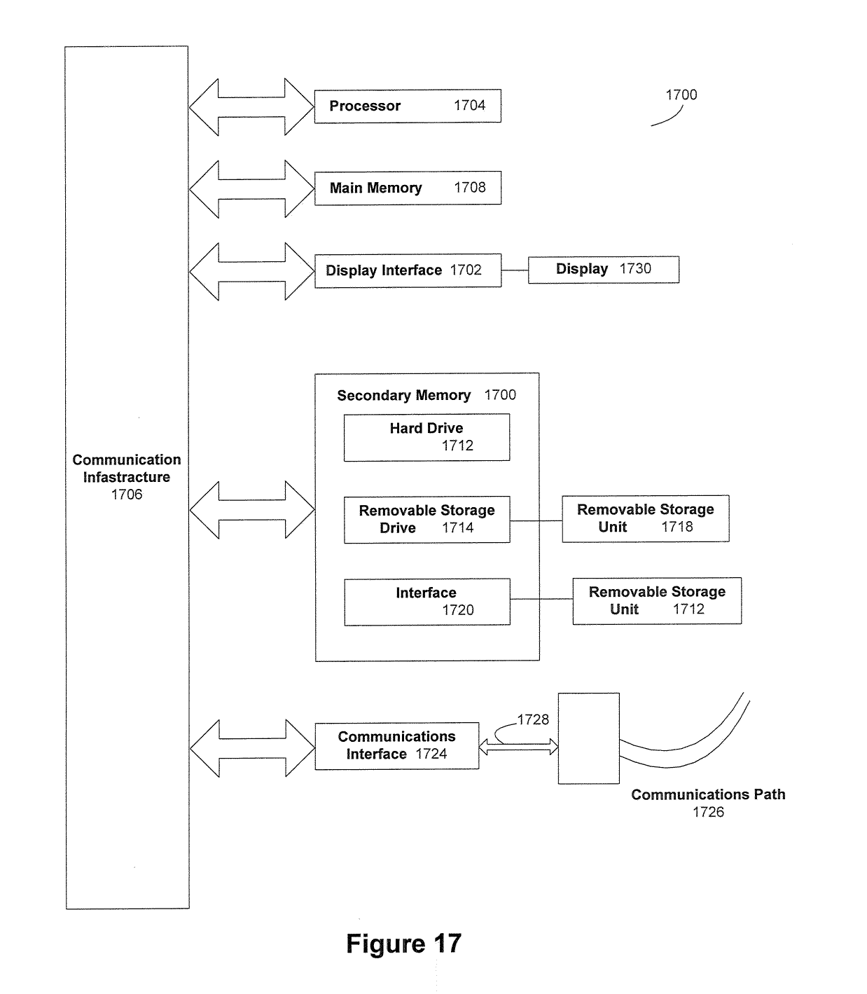

In one embodiment, the invention is directed toward one or more computer systems such as mobile devices capable of carrying out the functionality described herein having associated memory and databases. An example of a computer system 1700 of a sophisticated intelligent mobile device is shown in FIG. 17. The example does not show all aspects of a mobile device such as the camera, a clock, a time of day and date calendar, a GPS unit, an accelerometer and other features of a typical mobile device. However, such features of an ever improving digital camera are typically found in mobile devices known in the art and even comprise video cameras for capturing sequences of images if selected by a user.

Computer system 1700 includes one or more processors, such as processor 1704. The processor 1700 is programmed as a special purpose processor to authenticate a user using biometric (for example, facial structure) and a personal identification code entered by the user each time a mobile device is turned on and prepared for use by an individual user. The processor 1704 is connected to a communication infrastructure 1706 (e.g., a communications bus or network). Various software aspects are described in terms of this exemplary computer system. After reading this description, it will become apparent to a person skilled in the relevant art(s) how to implement the invention using other computer systems and/or architectures.

Users of mobile devices (not shown) communicate with computer system 1700 by means of communications interface 1706, typically a touchscreen having a reprogrammable display or other interface known in the art. A typical mobile device computer used by a user may have a similar structure to computer system 1700, the difference being that computer system 1700 may comprise databases and memory. A mobile device, on the other hand, provides a user with access to any of these for creating new images or doing any of the creation of the images and image portions such as face, eye region and pupil as discussed above.

Computer system 1700 can include a display interface 1702 that forwards graphics, text and other data from the communication infrastructure 1706 for display on the display unit 1730. A display, as will be described herein, may provide a touch screen for, for example, entering data.

Computer system 1700 also includes a main memory 1708 for maintaining the authentication and image processing algorithms described above, preferably random access memory (RAM) for temporary data storage and may also include a secondary memory 1710. The secondary memory 1710 may or may not include, for example, a hard disk drive 1712 and/or a removable storage drive 1714, representing a floppy disk drive, a magnetic tape drive, an optical disk drive, etc. The removable storage drive 1714 reads from and/or writes to a removable storage unit 1718 in a well known manner. Removable storage unit 1718 represents a floppy disk, magnetic tape, optical disk, micro SD card, etc. which is read by and written to by removable storage drive 1714. As will be appreciated, the removable storage unit 1718 includes a computer usable storage medium having stored therein computer software and/or data.

In alternative aspects, secondary memory 1710 may include other similar devices for allowing computer programs or other code or instructions to be loaded into computer system 1700 (for example, downloaded upon user selection from a server). Such memory devices may include, for example, a removable storage unit 1722 and an interface 1720. Examples of such may include a program cartridge and cartridge interface (such as that found in some video game devices), a removable memory chip (such as an erasable programmable read only memory (EPROM), or programmable read only memory (PROM)) and associated socket and other removable storage units 1722 and interfaces 1720, which allow software and data to be transferred from the removable storage unit 1722 to computer system 1700.

Computer system 170 also includes a communications interface 1724 which may be a cellular radio transceiver known in the cellular arts. Mobile communications interface 1724 allows software and data to be transferred between computer system 1700 and external devices and may comprise access to telecommunications, texting, the internet, social networks, movies via NetFlix, games and the like but only after authentication. As discussed above, a biometric and personal identification code multi-factor gaze authentication is presented for use with obtaining access to such device features. Examples of communications interface 1724 may include a modem, a network interface (such as an Ethernet card), an RF communications port, a Personal Computer Memory Card International Association (PCMCIA) slot and card, etc. Software and data transferred via communications interface 1724 are in the form of non-transitory signals 1728 which may be electronic, electromagnetic, optical or other signals capable of being received by communications interface 1724. These signals 1728 are provided to communications interface 1724 via a telecommunications path (e.g., channel) 1726. This channel 1726 carries signals 1728 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 1714, a hard disk installed in hard disk drive 1712 and signals 1728. Not all intelligent mobile devices have all these features. These computer program products provide software to computer system 1700. The invention is directed to computer authentication methods and apparatus.

Computer programs (also referred to as computer control logic) are typically stored in main memory 1708 and/or secondary memory 1710. Computer programs may also be received via communications interface 1724. Such computer programs, when executed, enable the computer system 1700 to perform the features of the present invention, as discussed herein. In particular, the authentication computer programs of the present invention, when executed, enable the processor 1704 to perform the features of the present invention and provide access to further features that are virtually unlimited (but importantly, personal to a user individual and should not be accessed by others without permission from the user). Accordingly, such computer programs represent controllers of the computer system 1700.

In an embodiment where the invention is implemented using software, the software may be stored in a computer program product and loaded into computer system 1700 using removable storage drive 1714, hard drive 1712 or communications interface 1724. The control logic (software), when executed by the processor 1704, causes the processor 1704 to perform the functions of the invention as described herein. The present authentication method and apparatus may be downloadable to a mobile device from an applications store.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

As will be apparent to one skilled in the relevant art(s) after reading the description herein, the computer architecture shown in FIG. 17 may be configured as any number of computing devices such as a system manager, a work station, a game console, a portable media player, a desktop, a laptop, a server, a tablet computer, a PDA, a mobile computer, a smart telephone, a mobile telephone, an intelligent communications device or the like. All non-patent literature, U.S. patents and U.S. published patent applications cited herein and below in the Bibliography should be deemed incorporated by reference as to their entire contents for any purpose. A Bibliography of source literature is provided below.

### BIBLIOGRAPHY

[1] Adams, A. and Sasse, M. A. (1999). Users are not the enemy. Commun. ACM, page 4046. 17
[2] Almuairfi, S., Veeraraghavan, P., and Chilamkurti, N. (2011). IPAS: implicit password authentication system. In 2011 IEEE Workshops of International Conference on Advanced Information Networking and Applications (WAINA), pages 430-435. 5, 7, 59
[3] Bednarik, R., Kinnunen, T., Mihaila, A., and Fränti, P. (2005). Eye-movements as a biometric. In Kalviainen, H., Parkkinen, J., and Kaarna, A., editors, Image Analysis, number 3540 in Lecture Notes in Computer Science, Springer Berlin Heidelberg, pages 780-789. 14
[4] Bonneau, J., Herley, C., van Oorschot, P., and Stajano, F. (2012). The quest to replace passwords: A framework for comparative evaluation of web authentication schemes. In 2012 IEEE Symposium on Security and Privacy (SP), pages 553-567. 2
[5] Corcoran, P., Nanu, F., Petrescu, S., and Bigioi, P. (2012). Real-time eye gaze tracking for gaming design and consumer electronics systems. IEEE Transactions on Consumer Electronics, pages 347-355. 12
[6] De Luca, A., Weiss, R., and Drewes, H. (2007). Evaluation of eye-gaze interaction methods for security enhanced PIN-entry. In Proceedings of the 19th Australasian conference on Computer-Human Interaction: Entertaining User Interfaces, page 199202, New York, N.Y. USA. ACM. 14
[7] DeFigueiredo, D. (2011). The case for mobile two-factor authentication. IEEE Security Privacy, pages 81-85. 5
[8] Ephraim, T., Himmelman, T., and Siddiqi, K. (2009). Real-time viola-jones face detection in a web browser. In Canadian Conference on Computer and Robot Vision, 2009. CRV '09, pages 321-328. 12
[9] Fan, C.-I. and Lin, Y.-H. (2009). Provably secure remote truly three-factor authentication scheme with privacy protection on biometrics. IEEE Transactions on Information Forensics and Security, pages 933-945. 10
[10] Fini, M., Kashani, M., and Rahmati, M. (2011). Eye detection and tracking in image with complex background. In 2011 3rd International Conference on Electronics Computer Technology (ICECT), pages 57-61.
[11] Hansen, D. and Ji, Q. (2010). In the eye of the beholder: A survey of models for eyes and gaze. IEEE Transactions on Pattern Analysis and Machine Intelligence, pages 478-500.
[12] Hennessey, C. and Lawrence, P. (2009a). Improving the accuracy and reliability of remote system-calibration-free eye-gaze tracking. IEEE Transactions on Biomedical Engineering, pages 1891-1900. 13
[13] Hennessey, C. and Lawrence, P. (2009b). Noncontact binocular eye-gaze tracking for point-of-gaze estimation in three dimensions. IEEE Transactions on Biomedical Engineering, pages 790-799. 13
[14] Hennessey, C., Noureddin, B., and Lawrence, P. (2008). Fixation precision in high-speed noncontact eye-gaze tracking. IEEE Transactions on Systems, Man, and Cybernetics, Part B: Cybernetics, pages 289-298. 13
[15] Herley, C. and Van Oorschot, P. (2012). A research agenda acknowledging the persistence of passwords. IEEE Security Privacy, pages 28-36. 2
[16] Huang, S.-H. and Lai, S.-H. (2004). Real-time face detection in color video. In Multimedia Modelling Conference, 2004. Proceedings. 10th International, pages 338-345.
[17] Huang, X., Xiang, Y., Chonka, A., Zhou, J., and Deng, R.-H. (2011). A generic framework for three-factor authentication: Preserving security and privacy in distributed systems. IEEE Transactions on Parallel and Distributed Systems, pages 1390-1397. 10
[18] Jiang, N., Lu, Y., Tang, S., and Goto, S. (2010). Rapid face detection using a multi-mode cascade and separate haar feature. In 2010 International Symposium on Intelligent Signal Processing and Communication Systems (ISPACS), pages 1-4. 13
[19] Jiang, N., Yu, W., Tang, S., and Goto, S. (2011). A cascade detector for rapid face detection. In 2011 IEEE 7th International Colloquium on Signal Processing and its Applications (CSPA), pages 155-158.
[20] Kashani, M., Arani, M., and Fini, M. (2011). Eye detection and tracking in images with using bag of pixels. In 2011 IEEE 3rd International Conference on Communication Software and Networks (ICCSN), pages 64-68.
[21] Kasprowski, P. and Ober, J. (2004). Eye movements in biometrics. In Maltoni, D. and Jain, A. K., editors, Biometric Authentication, Lecture Notes in Computer Science, pages 248-258. Springer Berlin Heidelberg. 14
[22] Kumar, M., Garfinkel, T., Boneh, D., and Winograd, T. (2007). Reducing shoulder-surfing by using gaze-based password entry. In Proceedings of the 3rd symposium on Usable privacy and security, page 1319, New York, N.Y., USA. ACM. 14
[23] Liang, Z., Tan, F., and Chi, Z. (2012). Video-based biometric identification using eye tracking technique. In 2012 IEEE International Conference on Signal Processing, Communication and Computing (ICSPCC), pages 728-733. 14
[24] Liou, J.-C., Egan, G., Patel, J., and Bhashyam, S. (2011). A sophisticated RFID application on multi-factor authentication. In 2011 Eighth International Conference on Information Technology: New Generations (ITNG), pages 180-185. 7, 9
[25] Maeder, A. J. and Fookes, C. B. (2003). A visual attention approach to personal identification. In Faculty of Built Environment and Engineering; School of Engineering Systems, pages 1-7. 14
[26] Majumder, A., Behera, L., and Subramanian, V. (2011). Automatic and robust detection of facial features in frontal face images. In 2011 UkSim 13th International Conference on Computer Modelling and Simulation (UKSim), pages 331-336.
[27] Mao, Z., Florencio, D., and Herley, C. (2011). Painless migration from passwords to two factor authentication. In 2011 IEEE International Workshop on Information Forensics and Security (WIFS), pages 1-6. x, 2, 7, 8
[28] Mehrubeoglu, M., Pham, L. M., Le, H. T., Muddu, R., and Ryu, D. (2011). Real-time eye tracking using a smart camera. In 2011 IEEE Applied Imagery Pattern Recognition Workshop (AIPR), pages 1-7.
[29] Mei, Z., Liu, J., Li, Z., and Yang, L. (2011). Study of the eye-tracking methods based on video. In 2011 Third International Conference on Computational Intelligence, Communication Systems and Networks (CICSyN), pages 1-5. 12
[30] Millan, M. S., Perez-Cabre, E., and Javidi, B. (2006). Multifactor authentication reinforces optical security. Optics Letters, pages 721-723. 10
[31] Miyazaki, S., Takano, H., and Nakamura, K. (2007). Suitable checkpoints of features surrounding the eye for eye tracking using template matching. In SICE, 2007 Annual Conference, pages 356-360.
[32] Morris, R. and Thompson, K. (1979). Password security: a case history. Commun. ACM, page 594597. 1
[33] Nanu, F., Petrescu, S., Corcoran, P., and Bigioi, P. (2011). Face and gaze tracking as input methods for gaming design. In Games Innovation Conference (IGIC), IEEE International, pages 115-116.
[34] O'Gorman, L. (2003). Comparing passwords, tokens, and biometrics for user authentication. Proceedings of the IEEE, pages 2021-2040. 1, 2
[35] Phiri, J., Zhao, T.-J., and Agbinya, J. (2011). Biometrics, device metrics and pseudo metrics in a multifactor authentication with artificial intelligence. In 2011 6th International Conference on Broadband and Biomedical Communications (IB2Com), pages 157-162. 10
[36] Radman, A., Jumari, K., and Zainal, N. (2013). Fast and reliable iris segmentation algorithm. IET Image Processing, 7(1):42-49. 32
[37] Skracic, K., Pale, P., and Jeren, B. (2013). Knowledge based authentication requirements. In 2013 36th International Convention on Information Communication Technology Electronics Microelectronics (MIPRO), pages 1116-1120. 5
[38] Sun, Q., Li, Z., Jiang, X., and Kot, A. (2008). An interactive and secure user authentication scheme for mobile devices. In IEEE International Symposium on Circuits and Systems, 2008. ISCAS 2008, pages 2973-2976. 10
[39] Tiwari, A., Sanyal, S., Abraham, A., Knapskog, S. J., and Sanyal, S. (2011). A multi-factor security protocol for wireless payment—secure web authentication using mobile devices. Technical report, India Institute of Information Technology. 9
[40] Udayashankar, A., Kowshik, A., Chandramouli, S., and Prashanth, H. S. (2012). Assistance for the paralyzed using eye blink detection. In 2012 Fourth International Conference on Digital Home (ICDH), pages 104-108. 12
[41] Uludag, U., Pankanti, S., Prabhakar, S., and Jain, A. (2004). Biometric cryptosystems: issues and challenges. Proceedings of the IEEE, pages 94&-960. xi, 60, 61
[42] Viola, P. and Jones, M. (2001a). Rapid object detection using a boosted cascade of simple features. In Proceedings of the 2001 IEEE Computer Society Conference on Computer Vision and Pattern Recognition, 2001. CVPR 2001, volume 1, pages 1-511-1-518 vol. 11
[43] Viola, P. and Jones, M. (2001b). Robust real-time face detection. In Eighth IEEE International Conference on Computer Vision, 2001. ICCV 2001. Proceedings, volume 2, pages 747-747.
[44] Vipin, M., Sarad, A., and Sankar, K. (2008). A multi way tree for token based authentication. In 2008 International Conference on Computer Science and Software Engineering, pages 1011-1014. 9
[45] Yan, B., Gao, L., and Zhang, X. (2009). Research on feature points positioning in non-contact eye-gaze tracking system. In 9th International Conference on Electronic Measurement Instruments, 2009. ICEMI '09, pages 1042-1045. 13
[46] Yang, C., Sun, J., Liu, J., Yang, X., Wang, D., and Liu, W. (2010). A gray difference-based pre-processing for gaze tracking. In 2010 IEEE 10th International Conference on Signal Processing (ICSP), pages 1293-1296. 13
[47] Yuan, Z. and Kebin, J. (2011). A local and scale integrated feature descriptor in eye-gaze tracking. In 2011 4th International Congress on Image and Signal Processing (CISP), pages 465-468.
[48] Zhu, Z. and Ji, Q. (2007). Novel eye gaze tracking techniques under natural head movement. IEEE Transactions on Biomedical Engineering, pages 2246-2260. 13

What I claim is:

1. Apparatus for authenticating a user of a mobile device comprising
a camera of the mobile device for capturing an image of an eye of the user of the mobile device, the camera providing an output to a processor of the image of the eye,
the processor for locating the pupil of an eye within the eye image, for calculating a direction of gaze of the eye of the user and for providing an output indicating the direction of gaze to a memory of the mobile device, and
a display for displaying an indication of the direction of gaze of the user indicative of a means for authenticating the user to the mobile device.

2. Apparatus for authenticating a user according to claim 1,
the processor initially processing an image of the user's face to locate a region of the eye before locating the pupil of the eye in the located eye region.

3. The authentication apparatus of claim 1 further comprising
the memory for storing the calculated direction of gaze of the eye of the user and a predetermined sequence of gazes of the eye of the user, the predetermined sequence having been selected and input via an input device into the memory,
the camera capturing a sequence of gazes of the eye of the user,
the processor for calculating the sequence of gazes of the eye of the user and associating the sequence of gazes with the predetermined stored sequence of gazes,
the processor for determining a match between the calculated sequence of gazes of the eye of the user and the predetermined stored sequence of gazes, and
the processor, if there is a match between the calculated sequence of gazes of the eye of the user and the predetermined stored sequence of gazes, authenticating the user to the mobile device.

4. The authentication apparatus of claim 3, further comprising
a personal identification code stored in the memory comprising a predetermined number of eye gazes in sequence between four and twelve eye gazes in length.

5. The authentication apparatus of claim 4, the predetermined number of eye gazes in sequence being stored in the memory during a personal identification code input phase by the user, the processor outputting the stored personal identification code for user verification.

6. The authentication apparatus of claim 1,
the display for displaying a plurality of one of different shapes, colors, numerals, objects, photographic images and drawings in a predetermined pattern on the screen in the form of an array of N lines by M columns where N is an integer number greater than two and less than ten and M is a number greater than two and less than ten.

7. The authentication apparatus of claim 1,
the display comprising a predetermined pattern of filled color rectangles, each rectangle having a predetermined different color.

8. The authentication apparatus of claim 7,
the predetermined stored sequence of gazes of the eye of the user comprising a personal identification code of length L, where L may comprise an integer between four and twelve,
the display pattern comprising a pattern of one of between three and five lines and between three and six columns.

9. The authentication apparatus of claim 3, the stored predetermined sequence of gazes comprising a sequence of gazes of one of different shapes, colors, numerals, objects, photographic images, drawings and patterns.

10. The authenticating apparatus of claim 1, the processor further comprising a clock for measuring the duration of a gaze in a calculated direction for comparison with an estimated range of durations of a gaze in the calculated direction, the processor outputting a display to the user if the user gaze duration falls outside the estimated range to request the user to begin gazing at the display again according to a predetermined selection of direction gazes.

11. A computer-implemented method for authenticating a user of a mobile device comprising
capturing an image of an eye of a user with a camera of the mobile device,
providing an output of the eye image to a processor of the mobile device,
locating, by the processor, a pupil of an eye within the eye image, the processor calculating a direction of gaze of the eye of the user and storing an indication of the direction of gaze in a memory of the mobile device, and
displaying an indication of the direction of gaze of the user indicative of a first direction of gaze for authenticating the user to the mobile device.

12. The computer-implemented method for authenticating a user of a mobile device of claim 11 further comprising
initially processing an image of the user's face to locate an eye region.

13. The computer-implemented method for authenticating a user of a mobile device of claim 12 further comprising
differentiating the image of the user's face from the faces of other individuals.

14. The computer-implemented method for authenticating a user of a mobile device of claim 12 further comprising
determining the center of the eye region and locating the pupil of the eye.

15. The computer-implemented method for authenticating a user of a mobile device of claim 11 further comprising
determining the center of the pupil and calculating the difference between the center of the eye region and the the center of the pupil of the eye to obtain an indication of the direction of gaze of the user.

16. The computer-implemented method of authenticating a user of a mobile device of claim 11 further comprising
storing in the memory the calculated direction of gaze of the eye of the user and storing a predetermined sequence of gazes of the eye of the user, the predetermined sequence having been selected and input via an input device for storage in the memory by the user,
capturing a sequence of gazes of the eye of the user at a display of the mobile device,
calculating by the processor the sequence of gazes of the eye of the user and associating the sequence of gazes with the predetermined stored sequence of gazes,
the processor for determining a match between the calculated sequence of gazes of the eye of the user and the predetermined stored sequence of gazes, and
the processor, if there is a match between the calculated sequence of gazes of the eye of the user and the predetermined stored sequence of gazes, authenticating the user to the mobile device.

17. The computer-implemented method of claim 15,
the predetermined sequence of gazes of the eye of the user being stored in processor memory during a personal identification code input phase, the processor outputting the stored personal identification code for user verification.

18. The computer-implemented method of claim 11 further comprising
calculating a center of a region of the eye of the user,
determining the center of a pupil of the eye of the user,
calculating a difference between the center of the region of the eye of the user and the center of the pupil of the eye of the user, and
from the calculated difference, estimating a gaze point of the eye of the user on a display of the mobile device.

19. The computer-implemented method of authenticating a user of a mobile device of claim 11
the calculation of the direction of gaze of the user corresponding to one of a different shape, color, numeral, object, alphabetic character, photographic image and drawing,
repeating the calculation of the direction of gaze of the user as the direction of gaze of the user changes and
correlating a predetermined plurality of directions of gaze to a personal identification code stored in memory for authenticating the user to the mobile device.

20. The computer-implemented method of authenticating a user of a mobile device of claim 11 further comprising
Displaying an array of one of a plurality of different shapes, colors, numerals, objects, photographic images, drawings and patterns.
